(19) United States
(12) Patent Application Publication
(10) Pub. No.: US 2009/0061226 A1
(43) Pub. Date: Mar. 5, 2009

(54) SPHERICAL COMPOSITES ENTRAPPING NANOPARTICLES, PROCESSES OF PREPARING SAME AND USES THEREOF

(75) Inventors: Uri Banin, Mevasseret Zion (IL); David Avnir, Jerusalem (IL); Taleb Mokari, Jerusalem (IL); Hanan Sertchook, Jerusalem (IL)

Correspondence Address: Martin D Moynihan;PRTSI Inc, Post Office Box 16446, Arlington, VA, 22215, US

(73) Assignee: YISSUM RESEARCH DEVELOPMENT COMPANY OF THE HEBREW, Givat Ram, Jerusalem (IL)

(21) Appl. No.: 11/792,496

(22) PCT Filed: Dec. 7, 2005
(86) PCT No.: PCT/IL2005/001319

§ 371 Date: Oct. 14, 2008

(51) Int. Cl. B32B 1/00; C08K 3/22

(52) U.S. Cl. 428/402; 524/401

(57) ABSTRACT

Novel nanoparticles-entrapping spherical composites, composed of a metal oxide or semi-metal oxide and a hydrophobic polymer, are disclosed. The spherical composites are characterized by well-defined spherical shape, a narrow size distribution and high compatibility with various types of nanoparticles. Further disclosed are processes for preparing the nanoparticles-entrapping spherical composites and uses thereof.

### FIELD AND BACKGROUND OF THE INVENTION

The present invention relates to the field of material science and, more particularly, to novel nanoparticles-entrapping composites.

Nanoparticles, which are also referred to in the art as quantum dots and/or rods, are molecular aggregates having from a few hundreds to tens of thousands atoms that combine into a cluster being about 1-100 nanometers in diameter. Nanoparticles are larger than molecules but smaller than bulk solids and therefore frequently exhibit unique physical and chemical properties due to their size, lattice order and overall morphology (shape). Nanoparticles may have an amorphous form, a semi-crystalline form or a crystalline form. Nanoparticles having a crystalline form are known as nanocrystals. Nanocrystals are nanoparticles that exhibit the most unique spectral and semi-conductive characteristics.

Given that a nanoparticle is and intermediate state between single molecules and a solid and is practically all surface and no interior, the physical, chemical and mechanical properties of a nanocrystal can be finely controlled as it grows in size and varies in morphology. For example, by finely controlling the size and surface of a nanocrystal, properties such as the band-gap, conductivity, crystal lattice and symmetry and melting temperature, can be tuned.

At nano-scale, both the physical and chemical properties of a material are profoundly changed. The relative large surface area of each bare nanoparticle suggests that nanoparticles are very reactive. Hydrophilic nanoparticles and particularly nanocrystals tend to be less stable and therefore exhibit instability in their photo-electronic characteristics. Nanocrystals can be stabilized by, for example, the addition of surfactant molecules to the preparation process thereof. The resulting nanocrystals are hydrophobic and exhibit high stability and thus improved quality characteristics. The surfactant caps and stabilizes the surface of nanocrystals. If no surfactant is applied, the freshly made nanocrystals coalesce with one another to form heavily twinned larger nanocrystals or bigger and highly mosaic microcrystals. Following the addition of a surfactant, nanocrystals can maintain their nano-scale size and shape, which translates in a more stable photo-electronic behavior. To state the matter differently, after an inorganic nanocrystal is coated with a densely packed monolayer of surfactant molecules, the surface of nanocrystals becomes hydrophobic, and the formed nanocrystals are stable and suspendable in non-polar solvents, forming stable colloids. After the solvent is evaporated or otherwise removed, the passivated nanocrystals may rearrange themselves to form assemblies instead of fusing together in an attempt to share the same lattice. This is due to the separating thin layer of surfactant molecules.

In recent years there has been a major progress in methods for controlling the growth of nanocrystals of semiconducting, metallic, magnetic and oxide materials. Shape-control growth methods have enabled the preparation of nanoparticles in various forms such as dots, rods, tetrapods and more. It has been recognized that the size-, composition- and shape-dependent properties of such nanocrystals can be harnessed for a variety of applications in areas ranging from biological fluorescent tagging, medical devices and therapeutics to light emitting diodes, lasers and chemical catalysts.

An efficient use of nanocrystals in these applications is, however, oftentimes limited by the difficulties associated with handling nanocrystals. Nanocrystals are difficult to locate, affix and follow, especially when a uniform distribution thereof is required over a given fix area. In addition, the photo-electronic characteristics of nanocrystals depend on their shape and surface, and as such any chemical or physical change may adversely affect their characteristics.

A significant challenge for obtaining stable optical properties and realizing optical and electronic applications of semiconductor nanocrystals is to affix and protect the nanocrystals by a suitable transparent host matrix which would not affect the desired characteristics of the nanocrystals. These requirements called for the development of means for growing or otherwise incorporating these difficult to handle entities into various carrier matrices, which are easier to manipulate. This approach further enables to utilize otherwise toxic nanocrystals, in applications such as biomedical applications, in which low toxicity is required.

To this end, a number of methodologies for entrapping nanocrystals in various matrices have been developed.

Thus, for example, encapsulation of various nano-sized particles using polystyrene-co-vinyl pyridine, polystyrene, silica gel or polylauryl methacrylate was described by Zhao et al. (Chem. Mater. Vol. 14, 1418, 2002), Han et al. (Nature Biotech., Vol. 19, 631, 2001), Correa-Duarte et al. (Chem. Phys. Letters, Vol. 286, 497, 1998), Chang et al. (J. Am. Chem. Soc., Vol. 116, 6739, 1994) and Lee et al. (Adv. Mater., Vol. 12, 1102, 2000).

Carrier matrices for entrapment of nanocrystals, which have drawn much attention in recent years, are ceramic and oxide-glass sol-gel materials. Entrapment of nanocrystals in such matrices is highly beneficial since, on one hand, these durable matrices provide protection and compatibility for high-quality nanocrystals with various environments and on the other hand, they impart specific properties of the nanocrystals to the carrier matrix. The encapsulation and entrapment of semiconducting and other nanocrystals within sub-micron hydrophobic or hydrophilic composite sol-gel spheres as a method of protecting nanocrystals has been described, for example, by Correa-Duarte, M, A et al. in Chem. Phys. Lett., 1998, 286, 497-501.

Early attempts for entrapping nanocrystals in sol-gel matrices involved the direct growth of the nanoparticles within glassy matrices. According to this strategy, sol-gel solutions were doped by cadmium ions and the resulting gels were heat-treated in H₂S, forming CdS nanocrystals [Lifshitz, E. et al., Chem. Phys. Lett. 1998, 288, 188]. In yet another approach, thermal decomposition of sulfur containing Cd²+ complexes was used to generate nanocrystals within a matrix [Mathieu, H. et al., J. Appl. Phys. 1995, 77, 287]. However, the resulting materials were plagued by poorly controlled surface passivation (which causes a surface to be less chemically reactive), low filling factors, and large size disparities and dispersities, and in general, these approaches were found incompatible with the requirement for high quality nanocrystals-containing materials.

A different approach, aimed at incorporating nanocrystals in sol-gel matrices focused primarily on hydrophilic, water-soluble nanocrystals. For instance, CdS and PbS particles were prepared in aqueous solution and were subsequently added to a sol [Pellegri, N. et al., J. Sol-Gel Sci. Tech., 1997, 8, 1023; Martucci, A. et al., J. Appl. Phys. 1999, 86, 79]. Recently, additional types of water-soluble semiconductor nanocrystals were entrapped in silica particles by sol-gel process forming a “raisin bun” type of particle dispersion [Rogach, A. L. et al., Chem. Mater., 2000, 12, p. 2676]. U.S. Patent Application having the publication No. 20050147974 discloses luminescent, spherical, transparent silica gel particles, encapsulating luminescent substance such as semiconducting nanocrystals in a silica gel matrix. These particles are prepared by dispersing a mixture of a silica sol and the luminescent substance in a water-immiscible organic phase, such that three-dimensionally cross-linked, pearl-shaped polymer carriers that contain the encapsulated luminescence substance are produced.

Unfortunately these methodologies are limited to incorporation of hydrophilic nanocrystals and are incompatible with hydrophobic nanocrystals which, as delineated hereinabove, are widely recognized as high quality nanocrystals.

The presently known methods for incorporating hydrophobic nanocrystals in sol-gel matrices involve the use of hydrophobically-modified sol-gel materials (also known as ormosils), which can naturally entrap hydrophobic nanocrystals without further treatment that could degrade their quality and performance. Yet, using this approach, monoliths doped with the nanocrystals, rather than complete entrapment of the nanocrystals, are obtained. This approach is further limited by the quality of the resulting matrices and to date did not produce high quality and shape-controlled results.

Another approach for incorporating hydrophobic nanocrystals in a sol-gel matrix is to modify the surface of the nanocrystals. A recent report described the synthesis of hybrid organic-inorganic monoliths, doped with core/shell semiconductor nanocrystals, and over-coated by hydrophobic surface ligands [Epifani, M. et al., J. Sol-Gel Sci. Tech., 2003, 26, 441-446]. The formation of sol-gel glasses doped with semiconductor nanocrystals while maintaining their efficient luminescence using alkylamines as base to catalyze rapid monolithic glass formation was also reported [Selvan, T. et al., Adv. Mater. 2001, 13, 985-988].

Yet another approach for incorporating nanocrystals into sol-gel matrices utilizes nanocrystals' surface modification by the addition of an amphiphilic polymer to the sol-gel/nanocrystals reaction mixture. Thus, U.S. Patent Application having the Publication No. 20050107478, WO 2005/049711 and WO 2005/047573 disclose a process for preparing a solid composite having colloidal nanocrystals dispersed within a sol-gel matrix, which is effected by admixing colloidal nanocrystals with an amphiphilic polymer and admixing the resulting alcohol-soluble colloidal nanocrystal-polymer complex with a sol-gel precursor. The resulting material therefore adapts a multilayered spherical structure in which the nanocrystals are entrapped by the hydrophobic region of the amphiphilic polymer, whereby the hydrophilic region of the polymer interacts with the external sol-gel matrix.

WO 2005/067524 discloses nanocrystals which have been modified by ligands that allow them to mix with various matrix materials. The ligands of the nanocrystals stem from molecules having head groups such as phosphoric acid, amines, carboxylic acids or thiol moieties, which have affinity for the nanocrystal surface, and tail groups that contain terminal hydroxyl groups that can tether the nanocrystal to a titania sol-gel matrix.

WO 2003/025539 and U.S. Patent Application having the publication No. 20030142944 teach a general concept of entrapping nanocrystals in a sol-gel solid matrix. According to the teachings of these patent applications, the surface-passivating ligands of hydrophobic nanocrystals are exchanged by ligands which stabilize the nanocrystals in hydrophilic solvents, and further allow tethering the ligated nanocrystals with a sol-gel matrix. The resulting composites, however, are obtained as bulky monolithic composites mostly in the form of layers.

U.S. Pat. No. 6,544,732, U.S. Application having the publication No. 20030175773 and EP 1181534 disclose compositions comprising a substrate with a surface that comprises discrete sites, whereby a population of nanocrystal-containing microspheres, optionally prepared by a sol-gel process, is distributed on these sites. These compositions can further comprise bioactive agents and/or identifier binding ligands and thus can be used, for example, to create unique optical signatures for encoding and decoding of array sensors. These patent applications, however, do not teach a process of encapsulating the nanocrystals in the sol-gel microspheres.

Other disclosures which teach the incorporation of nanocrystals in sol-gel matrices include, for example, WO2004066346, WO2005024960, WO2002071013, WO2003062372, U.S. Application No. 20030082237, EP1578173, U.S. Application No. 20050206306, U.S. Pat. No. 5,866,039, WO2004092324, U.S. Application No. 20040142344 and U.S. Pat. No. 6,139,626. Some of these disclosures are limited to the preparation of layers of composite matrices and nanocrystals while others are limited to specific matrix material or specific nanocrystals, yet all these methods fail to provide a solution to a wider scope of applications and materials.

The prior art therefore fails to teach an efficient methodology for the entrapment of hydrophobic nanoparticles in particulated sol-gel matrices.

There is thus a widely recognized need for, and it would be highly advantageous to have, a method for entrapping nanoparticles, particularly hydrophobic nanoparticles, and more particularly hydrophobic nanocrystals, in sol-gel spherical particles, devoid of the above limitations.

In a search for an efficient method for entrapping nanoparticles in sol-gel spherical particles, the present inventors have envisioned, while conceiving the present invention, that efficient entrapment of nanoparticles, particularly hydrophobic nanoparticles, and more particularly of the high-quality hydrophobic nanocrystals can be effected while utilizing composite sol-gel sub-micron particles made of polymers and silica.

Composite sol-gel sub-micron particles made of polymers and silica have been taught with regard to various applications. These include, for example, catalysis, chromatography, controlled release, optics, and as materials additives (fillers).

Recently, a specific method for preparing sub-micron sized composite polystyrene/silica spheres by a sol-gel process has been described [Sertchook, H. and Avnir, D. Chem. Mater., 2003, 15, 1690-1694].

Thus, it was envisioned that by utilizing such a sol-gel technique, sub-micron sized particles that efficiently entrap hydrophobic nanoparticles can be obtained.

### SUMMARY OF THE INVENTION

While reducing the present invention to practice, it was surprisingly found that spherical composites, made of hydrophobic polymers and silica, and prepared by a particular sol-gel technique, efficiently entrap various types of nanoparticles, particularly hydrophobic nanocrystals, whereby the resulting nanoparticles-entrapping spherical composites are characterized by well-defined spherical shape, size distribution and discreteness and exhibit tunable optical functionality.

Thus, according to one aspect of the present invention there is provided a composition comprising a plurality of spherical composites, wherein each of the spherical composite comprises at least one sol-gel metal oxide or semi-metal oxide and at least one hydrophobic polymer, and further wherein at least one of the spherical composites comprises at least one nanoparticle entrapped therein.

According to further features in preferred embodiments of the invention described below, at least one of the spherical composites further comprises at least one functionalizing group attached thereto.

According to still further features in the described preferred embodiments the functionalizing group is selected from the group consisting of a chemical moiety and a bioactive moiety.

According to still further features in the described preferred embodiments the at least one sol-gel metal oxide and the at least one hydrophobic polymer are entangled to one another.

According to still further features in the described preferred embodiments an average size of the spherical composites ranges from about 0.01 μm to about 100 μm in diameter.

According to still further features in the described preferred embodiments an average size of the spherical composites ranges from about 0.01 μm to about 10 μm in diameter.

According to still further features in the described preferred embodiments at least 60% of the spherical composites have an average size that ranges from about 0.01 μm to about 10 μm in diameter.

According to still further features in the described preferred embodiments at least 90% of the spherical composites have an average size that ranges from 0.01 μm to about 10 μm in diameter.

According to still further features in the described preferred embodiments the spherical composites are discrete from one another.

According to still further features in the described preferred embodiments the at least one sol-gel metal oxide or semi-metal oxide is selected from the group consisting of SiO₂, TiO₂, ZrO₂, Al₂O₃, ZnO, SnO₂, MnO, an organically-modified derivative thereof, a functionalized derivative thereof and any mixture thereof.

According to still further features in the described preferred embodiments the at least one sol-gel metal oxide or semi-metal oxide is prepared from a sol-gel precursor selected from the group consisting of a metal alkoxide monomer, a semi-metal alkoxide monomer, a metal ester monomer, a semi-metal ester monomer, a silazane monomer, a monomer of the formula M(R)n(P)m, wherein M is a metallic or a semi metallic element, R is a hydrolyzable substituent, n is an integer from 2 to 6, P is a non polymerizable substituent and m is and integer from 0 to 6, a partially hydrolyzed and partially condensed polymer thereof, and any mixture thereof.

According to still further features in the described preferred embodiments the at least one metal oxide is silica.

According to still further features in the described preferred embodiments the at least one hydrophobic polymer is selected from the group consisting of a polyolefin, a polyaromatic, a polyalkylacrylate, a polyoxirane, a polydiene, a polylactone(lactide), a co-polymer thereof, a functionalized derivative thereof and any mixture thereof.

According to still further features in the described preferred embodiments the at least one hydrophobic polymer is a polyaromatic such as a polystyrene.

According to still further features in the described preferred embodiments the at least one nanoparticle is selected from the group consisting of a chromogenic nanoparticle, a semiconducting nanoparticle, a metallic nanoparticle, a magnetic nanoparticle, an oxide nanoparticle, a fluorescent nanoparticle, a luminescent nanoparticle, a phosphorescent nanoparticle, an optically active nanoparticle and a radioactive nanoparticle.

According to still further features in the described preferred embodiments the at least one nanoparticle has a dot, a rod, a disk, a tripod, or a tetrapod shape.

According to still further features in the described preferred embodiments the at least one nanoparticle is a hydrophobic nanoparticle.

According to still further features in the described preferred embodiments the hydrophobic nanoparticle comprises a core and a shell.

According to still further features in the described preferred embodiments the nanoparticle is selected from the group consisting of CdSe nanocrystal, CdSe/ZnS nanocrystal, InAs nanocrystal, InAs/ZnSe nanocrystal, Au nanocrystal and PbSe nanocrystal.

According to still further features in the described preferred embodiments a weight ratio of the at least one hydrophobic polymer and the at least one nanoparticle in the spherical composites ranges from about 1:10 to about 5:1.

According to still further features in the described preferred embodiments a weight ratio of the at least one hydrophobic polymer and the at least one nanoparticle in the spherical composites ranges from about 1:2 to about 3:1.

According to still further features in the described preferred embodiments a weight ratio of the at least one metal oxide or semi-metal oxide and the at least one hydrophobic polymer ranges from about 2:1 and about 50:1.

According to still further features in the described preferred embodiments a weight ratio of the at least one metal oxide or semi-metal oxide and the at least one nanoparticle in the spherical composites ranges from about 5:1 and about 20:1.

According to still further features in the described preferred embodiments the spherical composites exhibit a functional characteristic of the nanoparticle.

According to still further features in the described preferred embodiments the functional characteristic is selected from the group consisting of chromogenic activity, optical activity, spectral activity, semi-conductivity, photoelectronic reactivity, magnetism, and radioactivity.

According to another aspect of the present invention there is provided a process of preparing a plurality of spherical composites, wherein each spherical composite comprises at least one sol-gel metal oxide or semi-metal oxide as described herein and at least one hydrophobic polymer as described herein, and further wherein at least one of the spherical composites comprises at least one nanoparticles, as described herein, entrapped therein. The process comprises: providing a hydrophobic solution which comprises at least one sol-gel precursor, the at least one hydrophobic polymer and the at least one nanoparticle; and mixing the hydrophobic solution with a hydrophilic solution, to thereby obtain a mixture containing the plurality of the spherical composites.

According to further features in preferred embodiments of the invention described below, the spherical composites further comprise at least one functionalizing group attached thereto, whereas at least one of the sol-gel precursor and the hydrophobic polymer comprises the functionalizing group.

According to still further features in the described preferred embodiments the spherical composites further comprise at least one functionalizing group attached thereto, and the process further comprising: reacting the spherical composites with a functionalizing moiety, to thereby obtain the spherical composites having the functionalizing group attached thereto.

According to still further features in the described preferred embodiments hydrophobic solution further comprises a hydrophobic solvent.

According to still further features in the described preferred embodiments the hydrophilic solution further comprises a hydrophilic solvent.

According to still further features in the described preferred embodiments the hydrophilic solution further comprises a catalyst.

According to still further features in the described preferred embodiments the hydrophilic solution further comprises a surfactant.

According to still further features in the described preferred embodiments the process further comprises separating the composite microspheres from the mixture.

According to still further features in the described preferred embodiments a weight ratio of the at least one hydrophobic polymer and the at least one nanoparticle in the hydrophobic solution ranges from about 1:10 to about 5:1.

According to still further features in the described preferred embodiments a weight ratio of the at least one hydrophobic polymer and the at least one nanoparticle in the hydrophobic solution ranges from about 1:2 to about 3:1.

According to still further features in the described preferred embodiments a concentration ratio of the at least one hydrophobic polymer and the at least one sol-gel precursor in the hydrophobic solution ranges from about 10 mg per 1 ml and about 100 mg per 1 ml.

According to still further features in the described preferred embodiments a concentration ratio of the at least one hydrophobic polymer and the at least one sol-gel precursor in the hydrophobic solution ranges from about 30 mg per 1 ml and about 70 mg per 1 ml.

According to still further features in the described preferred embodiments a concentration ratio of the at least one sol-gel precursor and the at least one nanoparticle in the hydrophobic solution ranges from about 10 mg per 1 ml and about 50 mg per 1 ml.

According to still another aspect of the present invention there is provided a spherical composite comprising an entrapping matrix which comprises at least one sol-gel metal oxide or semi-metal oxide as described herein and at least one hydrophobic polymer as described herein, and at least one nanoparticle, as described herein, being entrapped in the matrix.

According to further features in preferred embodiments of the invention described below, the composite further comprises at least one functionalizing group, as described herein, attached thereto.

According to still further features in the described preferred embodiments the at least one sol-gel metal oxide and the at least one hydrophobic polymer are entangled to one another.

According to still further features in the described preferred embodiments the spherical composite has a size that ranges from about 0.01 μm to about 100 μm in diameter, preferably from about 0.01 μm to about 10 μm in diameter.

According to still further features in the described preferred embodiments the spherical composite exhibits a functional characteristic of the nanoparticles(s), as described herein.

According to yet another aspect of the present invention there is provided a functional thin layer comprising the composition described herein.

According to an additional aspect of the present invention there is provided an article-of-manufacture comprising the composition described herein.

The article-of-manufacture can be, for example, an affinity labeling agent, an array sensor, a barcoded tag and label, a chromogenic/radio/fluorescent immunoassay agent, a drug delivery agent, an optical amplifier, an electronic paper, a filler and a lubricant, a light emitting diode, a solid state lighting structure, an optical memory device, a dynamic holography device, an optical information processing system, an optical switching device, a solid state laser, a flow cytometry agent, a genetic mapping agent, an imaging probe, an immunohistochemical staining agent, a screening, a tracing, localizing and/or hybridization probe, an ink composition, a magnetic and/or affinity chromatography agent, an optical cavity resonator, a photonic band-gap structure, a magnetic liquid, an optical filter and a paint.

The present invention successfully addresses the shortcomings of the presently known configurations by providing finely-controlled spherical composites that efficiently entrap hydrophobic nanoparticles, and particularly hydrophobic nanocrystals, which are far superior to the presently known nanocrystal-entrapping sol-gel and polymeric matrices by the simplicity and controllability of their preparation, their compatibility with various nanocrystals, their tunable functional properties and the wide range of applications in which these spherical composites can be efficiently utilized.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

As used herein, the term “comprising” means that other steps and ingredients that do not affect the final result can be added. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

The term “method” or “process” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the singular form “a,” “an,” and “the” include plural references unless the context clearly dictates otherwise. For example, the term “a compound” or “at least one compound” may include a plurality of compounds, including mixtures thereof.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-d present analytic results obtained for CdSe/ZnS core/shell nano-rods (nanocrystals having a rod shape of 15 nm over 3.8 nm) entrapped in sol-gel silica/polystyrene microspheres, showing a TEM image of the nanocrystals (FIG. 1a), a TEM image of a single microsphere of about 100 nm in diameter entrapping the nanocrystals which are visible as dark spots (FIG. 1b), an energy dispersive X-ray spectroscopy spectra (EDS) of the microsphere/nanocrystals composites wherein Si, Cd, Se, Zn and S are detected in well pronounced peaks (FIG. 1c), and a high-resolution scanning elecromicrograph of three of the sol-gel/polystyrene/nanocrystals composite spheres having a diameter of about 500-600 nm (FIG. 1d);

FIGS. 2a-b present energy dispersive X-ray spectroscopy spectra of composite microspheres of about 0.5 μm in diameter entrapping PbSe nanocrystals of about 10 nm in diameter wherein peaks for silicon, lead and selenium are prominent (FIG. 2a), and of composite microspheres of about 0.75 μm in diameter entrapping Au nanocrystals of about 6 nm in diameter wherein peaks for silicon and gold are prominent, demonstrating the ability to entrap metallic nanocrystals (FIG. 2b);

FIGS. 3a-d present TEM images of exemplary composite microspheres entrapping CdSe/ZnS core/shell nano-rods (nanocrystals having a rod shape of 15 nm over 3.8 nm) showing a mass of indistinguishable particles before applying sonication to the sample (FIG. 3a), and well distinguishable spheres after sonication was applied (FIG. 3b), an aggregate of microspheres forming on carbon coated TEM grid (FIG. 3c) and well separated microspheres obtained on carbon-formvar coated TEM grid (FIG. 3d);

FIGS. 4a-d present TEM images of composite microspheres of 0.25 μm in diameter entrapping CdSe/ZnS core/shell nano-rods of 24.5 nm over 4.9 nm (FIG. 4a), composite microspheres of 0.5 μm in diameter entrapping CdSe/ZnS core/shell nano-dots of 3.5 nm in diameter (FIG. 4b), composite microspheres of 0.78 μm in diameter entrapping CdSe nano-dots of 6 nm in diameter (FIG. 4c) and composite microspheres of 1 μm in diameter entrapping CdSe/ZnS core/shell nano-rods of 11 nm over 3 nm (FIG. 4d), demonstrating the control over the final microsphere size at various preparation conditions;

FIGS. 5a-c present color images of UV lit films made of composite sol-gel/polystyrene microspheres entrapping luminescent CdSe/ZnS core/shell semiconducting nanocrystals, wherein the green emission is of composite sol-gel/polystyrene microspheres entrapping 11 nm over 3 nm CdSe/ZnS nano-rods (FIG. 5a); yellow emission is of composite sol-gel/polystyrene microspheres entrapping 3.6 nm CdSe/ZnS nano-dots (FIG. 5b); and red emission is of composite sol-gel/polystyrene microspheres entrapping 25 nm over 4.5 nm CdSe/ZnS nano-rods (FIG. 5c);

FIGS. 6a-d present scanning fluorescence microscopy images and photoluminescence spectra obtained at different integration times from three exemplary composite microspheres of about 500 nm in diameter, entrapping CdSe/ZnS core/shell nano-dots of 3.8 nm in diameter, showing a far field optical view of the microspheres (FIG. 6a), the two dimensional (FIG. 6b) and three-dimensional (FIG. 6c) photoluminescence distribution map of the microspheres, and the corresponding photoluminescence intensity spectra observed for these three microspheres (FIG. 6d); and

FIG. 7 presents the photoluminescence spectra of three exemplary composite microspheres entrapping CdSe/ZnS nanocrystals, showing a peak at 556 nm for entrapped core/shell nano-rods being 11 nm over 3 nm in size (denoted A), a peak at 586 nm for core/shell nano-dots being 3.8 nm in diameter (denoted B), a peak at 605 nm for core/shell nano-rods being 25 nm over 4 nm in size (denoted C); and the photoluminescence spectra of two exemplary composite microspheres entrapping InAs/ZnSe core/shell nano-dots, showing a peak at 1100 nm for core/shell nano-dots having a diameter of 4.3 nm (denoted D), and a peak at 1450 nm for core/shell nano-dots having a diameter of 6.3 nm in diameter (denoted E).

### DESCRIPTION OF THE PREFERRED EMBODIMENTS

The present invention is of novel nanoparticles-entrapping spherical composites, composed of a metal oxide or semi-metal oxide and a hydrophobic polymer. The spherical composites are characterized by well-defined spherical shape, a narrow size distribution and high compatibility with various types of nanoparticles, particularly hydrophobic nanoparticles, and more particularly with hydrophobic and/or hydrophobically coated nanocrystals. The present invention is further of processes for preparing the nanoparticles-entrapping spherical composites and of uses thereof in a myriad of applications.

The principles and operation of the process and the apparatus according to the present invention may be better understood with reference to the accompanying descriptions and examples.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

As discussed hereinabove, nanoparticles, and particularly nanocrystals, constitute an important family of materials which exhibit unique photo-electronic characteristics that stem directly from their chemical composition, three dimensional shape and nanoscale size. Being practically all surface, these chemical entities are highly reactive and therefore instable, and hence are difficult to manipulate and utilize.

As is further discussed hereinabove, the present inventors have envisioned the entrapment of nanoparticles, particularly hydrophobic nanoparticles, and more particularly of high-quality hydrophobic nanocrystals, can be efficiently effected in composite sol-gel sub-micron particles made of silica and various polymers, such as, for example, those described by Sertchook and Avnir [Chem. Mater., 2003, 15, 1690-1694, supra].

The sol-gel process is a well-known technique for preparing polymers of metal oxides by the hydrolysis of semi-metal alkoxide and/or metal alkoxide precursors (such as, for example, organoalkoxysilane compounds). In this process, an essentially aqueous sol (a colloid that has a continuous liquid phase in which a solid is suspended in a liquid) is first formed. During the process, particles of colloidal metal oxides in the sol gather into clusters or masses until a viscous, essentially aqueous liquid is first formed and then a solid colloidal gel structure (a colloid in which the disperse phase is interconnected to a network and has combined with the dispersion medium to produce a semisolid material) of an oxide network is formed. The process is typically performed at room temperature and is often effected in the presence of a catalyst. The resultant composition is an essentially aqueous metal oxide sol-gel composition which may be dried and cured to form an inorganic oxide network wherein semi-metal and metal atoms are proportionately dispersed throughout the oxide network.

This technique has been widely applied in the preparation of single component metal oxide glasses and ceramics, and in the preparation of multi-component, multi-metal oxide glasses and ceramics. Depending on the conditions under which the process is effected, the resulting metal/metalloid oxide polymer may be in the form of a monolithic article, a multitude of particles or may be applied as a coating composition to a surface of a substrate to form a glassy film. In addition, chemical, physical and morphological properties of the resulting polymer can be easily tailored by modifying the precursors used in the process, the catalyst and/or other components that participate in the process and the conditions under which the process is performed. The ability to finely control the properties of the resulting polymer and the mild conditions under which the process is performed render sol-gel polymers highly suitable as entrapping matrices of a myriad of moieties.

As is further discussed hereinabove, due to the aqueous environment required for the preparation of sol-gel polymers, most of the presently known technologies for entrapping nanoparticles in sol-gel matrices have been limited to hydrophilic nanoparticles.

Thus, it was envisioned that by incorporating a hydrophobic polymer in a sol-gel derived entrapping matrix, entrapment of hydrophobic nanoparticles could be effected due to the hydrophobic environment formed by the polymer, whereby the resulting composites would impart the necessary protection to the nanoparticles, while not obscuring their photo-electronic and other effects, due to the sol-gel metal oxide forming the entrapping matrix.

While reducing the present invention to practice, a process of preparing spherical composites, each comprising an entrapping matrix composed of a sol-gel metal oxide or semi-metal oxide and a hydrophobic polymer, and further entrapping nanocrystals, has been designed and successfully practiced. As is demonstrated in the Examples section that follows, entrapment of various hydrophobic nanocrystals was successfully and readily effected by this process, whereby the resulting nanocrystal-entrapping composite spheres were characterized as having a well-defined spherical shape and a nano-scaled size, and as being mono-dispersive and discrete from one another. Thus, discrete nanocrystal-entrapping composite spheres of controllable and uniform size, which can serve as a convenient and sustainable form for handling and using nanocrystals, and can further serve as functionalized sol-gel derived composites, were produced.

Hence, according to one aspect of the present invention, there is provided a composition which comprises a plurality of spherical composites, wherein each of the spherical composite comprises one or more sol-gel metal oxide or semi-metal oxide and one or more hydrophobic polymer, and further wherein at least one of the spherical composites further comprises one or more types of nanoparticles entrapped therein. These spherical composites are also referred to herein throughout as nanoparticles-entrapping spherical composites. Due to the preferred micro-size of the spherical composites, discussed hereinabove, the spherical composites are also referred to herein as nanoparticles-entrapping composite microspheres and/or simply composite microspheres.

The term “entrap” and its grammatical diversions, as used in the context of the present invention, relate to any form of accommodating a substance, herein the nanoparticles, within a matrix, herein the spherical composite matrix. Preferably, entrapment of the nanoparticles in the spherical composites, as in the context of the present invention, describes complete integration of the nanoparticle within the composite, such that the entrapped nanoparticles are fully isolated from the surrounding environment.

The term “spherical”, as used herein, refers to a three-dimensional characteristic of an object having the shape approximating that of a sphere, a globe or a ball, being essentially orbicular, round and globular.

The term “composite”, as used herein, describes a solid material which is composed of two or more substances having different characteristics and in which each substance retains its identity while contributing desirable properties to the whole.

The term “semi-metal”, which is also referred to, interchangeably, herein and in the art as “metalloid”, describes a nonmetallic element, such as silicone, having properties which are intermediate between those of metals and those of nonmetals. There is no unique way of distinguishing a metalloid from a true metal but the most common is that metalloids are usually semiconductors rather than conductors. Like metals, the conduction band and valence band of metalloids overlap, but metalloids have a low carrier density relative to metals. Examples of metalloids include boron (B), silicon (Si), germanium (Ge), arsenic (As), antimony (Sb), tellurium (Te) and polonium (Po). Preferably, the semi-metal, according to the present embodiments, is silicone.

The term “sol-gel metal oxide or semi-metal oxide”, which is also abbreviated herein to “sol-gel oxide”, as used herein, describes a metal oxide or a semi-metal oxide obtained via a sol-gel process, as described in detail hereinabove. As is well-known in the art, due to its production via a specific process, the sol gel metal oxide or semi-metal oxide is characterized by properties that are unique to this process. These include, for example, a finely-controlled three-dimensional network of the oxide.

Representative examples of sol-gel metal oxides and semi-metal oxides that are suitable for use in the context of the present invention include, without limitation, silica (SiO₂), titania (TiO₂), zirconia (ZrO₂), alumina (Al₂O₃), zinc oxide (ZnO), tin dioxide (SnO₂), manganese oxide (MnO) and any mixture thereof. Preferably, the semi-metal oxide is silica.

Alternatively, one or more of, and optionally the sole sol-gel semi-metal oxide(s) or metal oxide(s) composing the spherical composite is an organically-modified semi-metal oxide or metal oxide, also known and referred to in the art as ORMOSILS (organically modified silicates) or ORMOCERS (organically modified ceramics). Such sol-gel oxides are typically prepared from sol-gel precursors which include one or more non-polymerizable organic substituents, which do not participate in the hydrolysis reactions that lead to the formation of the sol and the gel.

Further alternatively, one or more of the sol-gel semi-metal oxide or metal oxide composing the spherical composite is a functionalized semi-metal oxide or metal oxide, as is detailed hereinunder.

The various sol-gel metal oxides or semi-metal oxides which may be incorporated within the spherical composites described herein can be collectively described as prepared by a sol-gel process from a sol-gel precursor such as, but not limited to, a metal alkoxide monomer, a semi-metal alkoxide monomer, a metal ester monomer, a semi-metal ester monomer, a silazane monomer, a monomer of the formula M(R)n(P)m, wherein M is a metallic or a semi metallic element, R is a hydrolyzable substituent, n is an integer from 2 to 6, P is a non polymerizable substituent and m is and integer from 0 to 6, a partially hydrolyzed and partially condensed polymer thereof, and any mixture thereof.

Non-modified metal oxides or semi-metal oxides are typically prepared from sol-gel precursors having the formula M(R)n(P)m, wherein M is a metallic or a semi metallic element, R is a hydrolyzable substituent, n is an integer from 2 to 6, and m is 0.

Organically-modified sol-gel oxides are typically prepared from a sol-gel precursor of the formula M(R)n(P)m, wherein “M” is a metallic or semi-metallic element, “R” is a hydrolyzable substituent, “n” is an integer from 2 to 5, “P” is a non polymerizable substituent and “m” is an integer from 1 to 6.

Functionalized sol-gel oxides can be obtained from sol-gel precursors of the formula M(R)n(P)m, wherein “M” is a metallic or semi-metallic element, “R” is a hydrolyzable substituent, “n” is an integer from 2 to 5, “P” is a non polymerizable substituent and “m” is an integer from 1 to 6, whereby at least one of the non-polymerizable substituent is a functionalizing group, as described herein.

Representative examples of commonly used sol-gel precursors from which the sol-gel oxides can be prepared and used within the spherical composites include, but are not limited to, tetraethoxytitanate, tetraethylorthosilicate (TEOS), (3,3,3-trifluoropropyl)methyldimethoxysilane, (3,3,3-trifluoropropyl)trimethoxysilane, (Cyanomethylphenethyl)triethoxysilane, (Cyanomethylphenethyl)trimethoxysilane, 1,4-Bis(hydroxydimethylsilyl)benzene, 1,4-bis(trimethoxysilylethyl)benzene, 2-Cyanoethyltriethoxysilane, 2-Cyanoethyltrimethoxysilane, 3-(2,2,6,6-tetramethylpiperidine-4-oxy)-propyltriethoxysilane, 3-(N-styrylmethyl-2-aminoethylamino)-propyltrimethoxysilane hydrochloride, 3-(trimethoxysilyl)propyl methacrylate (MEMO), 3-[2-N-benzyaminoethylaminopropyl]trimethoxysilane hydrochloride, 3-Cyanopropyldimethylmethoxysilane, 3-Cyanopropyltriethoxysilane, 3-Cyanopropyltrimethoxysilane, bis(2-hydroxyethyl)-3-aminopropyltriethoxysilane, methyl-n-Octadecyldiethoxysilane, methyl-n-Octadecyldimethoxysilane, methyltriethoxysilane, methyltriethoxytitanate, N-(3-triethoxysilylpropyl)acetyl-glycinamide, N-(3-trimethoxysilylpropyl)-N-methyl-N,N-diallylammonium chloride, N-Dodecyltriethoxysilane, N-Dodecyltrimethoxysilane, N-Hexyltriethoxysilane, n-isobutyltriethoxysilane, N-octadecyldimethyl[3-(trimethoxysilyl)propyl]ammonium chloride, N-octadecyldimethylmethoxysilane, N-octadecyltriethoxysilane, N-octadecyltrimethoxysilane, n-octylmethyldimethoxysilane, N-octyltriethyoxysilane, N-octyltrimethoxysilane, N-ocyidiisobutylmethoxysilane, N-phenylaminopropyltrimethoxysilane, N-propyltrimethoxysilane, N-tetradecyldimethyl(3-trimethoxysilylpropyl)ammonium chloride, N-trimethoxysilylpropyl-N,N,N-trimethylammonium chloride, N-trimethoxysilylpropyltri-N-butylammonium bromide, phenethyltrimethoxysilane, phenyltriethoxysilane, phenyltriethoxytitanate, polyethoxydisiloxane (PEDS), styrylethyltrimethoxysilane, tetraethoxysilane, tetramethoxysilane, tetramethoxysilane, tetramethylorthosilicate (TMOS), tetrapropylorthosilicate (TPOS), Ti(IV)-butoxide, trimethoxysilylpropylthiouronium chloride, vinyltrimethoxysilane (VTMOS) and Zr(IV)-propoxide.

One of the most commonly used semi-metal oxide sol-gel precursor is tetraethylorthosilicate (TEOS).

The use of TEOS as a sol-gel precursor for obtaining a sol-gel silica gives rise to a durable and transparent silica glass which is highly suitable for the purpose of entrapment of nanoparticles. Hence, according to a preferred embodiment of the present invention the sol-gel metal oxide or semi-metal oxide is silica, preferably prepared from TEOS.

As discussed hereinabove, the polymer constituting an additional component in the spherical composites presented herein is selected hydrophobic so as to enable the incorporation and subsequent entrapment of hydrophobic or hydrophobically coated nanoparticles in the resulting composite spheres. The polymer is further selected suitable for forming the composite together with the sol-gel oxide.

As used herein, the term “polymer” describes a large molecule made up of repeating units. Polymers may be classified by their repeating unit structure and may be linear, branched or, less commonly, cyclic. Copolymers contain two or more different monomers that can be arranged randomly or in repeating sequence blocks in the polymeric structure. In solution, entangled polymer chains can create networks, giving complex viscosity behavior. Generally, the term “polymer” encompasses, but is not limited to, homopolymers, co-polymers, such as for example, block, graft, random and alternating co-polymers, ter-polymers, and blends and modifications thereof, of various molecular weights. Furthermore, unless otherwise specifically limited, the term “polymer” includes all possible stereochemical configurations and conformations of the molecule. These configurations and conformations include, but are not limited to, isotactic, syndiotactic and atactic, cis and trans, and R and S and conformations.

The term “hydrophobic” as used herein describes a characteristic of a substance that typically renders the substance water-insoluble.

The hydrophobic polymer, according to present embodiments, can be selected from any family of hydrophobic polymers such as, for example, polyolefins, polyaromatics (e.g., polystyrenes), polyalkylacrylates, polycarbonates, polyoxiranes, polydienes, polylactone(lactides), co-polymers thereof and any mixture thereof.

Preferably the hydrophobic polymer is a polyaromatic polymer, and more preferably it is a polystyrene. A polystyrene polymer can be polystyrene per se or derivatized polystyrene such as, for example, poly(4-acetoxy styrene), poly(3-bromo styrene), poly(4-bromo styrene), poly(4-t-butyl styrene), poly(4-chloro styrene), poly(4-hydroxyl styrene), poly(a-methyl styrene), poly(4-methyl styrene), poly(4-methoxy styrene), oligomer of styrene-dimer, butadiene terminated polystyrene, isotactic polystyrene, syndiotactic polystyrene, and/or atactic polystyrene.

Additional hydrophobic polymers that are suitable for use in the context of the present invention include, without limitation, polyolefins such as polyethylene or polypropylene, polyalkylacrylates and optically suitable polycarbonates.

One or more of or the sole hydrophobic polymer(s) composing the spherical composite can optionally, and depending on the intended use of the resulting composition, be a functionalized polymer having one or more functionalizing group attached thereto, as defined herein.

The sol-gel metal oxide or semi-metal oxide and the hydrophobic polymer composing the spherical composite interact so as to form a composite network that serves as an entrapping matrix for the nanoparticles. In a preferred embodiment of the present invention, the hydrophobic polymer and the sol-gel oxide are entangled or knotted to one another, such that molecular-level domains of each component are formed within the composite.

According to this embodiment, the structure formed between the hydrophobic polymer and the sol-gel oxide in the composite can also be described as resembling a plexus.

As used herein, the term “plexus”, which is typically used in the field of neurology, refers to a structure in the form of a network of interconnected and interlaced strands and hubs. Preferably, the plexus is composed of nano-sized domains of the hydrophobic polymer and the sol-gel oxide.

As is demonstrated in the Examples section that follows, the spherical composites described herein can efficiently entrap a nanoparticle.

Hence, according to another aspect of the present invention there is provided a spherical composite. The spherical composite is made of an entrapping matrix that comprises one or more sol-gel oxides as described herein and one or more hydrophobic polymers, and a nanoparticle that is entrapped in the matrix.

As used herein, the term “nanoparticle” describes one or more nano-sized discrete mass of solid particles being less than 1 micron in the largest axis thereof, and preferably being from about 1 to about 100 nanometers (nm).

Nanoparticles can be categorized by their crystallinity and hence can be crystalline nanoparticles (also known and referred to herein as nanocrystals), semi-crystalline nanoparticles or amorphous nanoparticles.

The term “crystalline” or “crystal” refers to a solid body bounded by natural plane faces that are the external expression of a regular internally ordered arrangement or lattice of constituent atoms, molecules, or ions.

The term “amorphous” as used herein refers to the lack of regular internally ordered arrangement, or the antithetical form of the crystalline form.

Preferred nanoparticles according to the present embodiments are nanocrystals.

The nanocrystals are generally members of a crystalline population having a narrow size distribution. The shape of nanocrystals can be a sphere, a rod, a disk, a tripod, a tetrapod and the like.

Nanoparticles can alternatively be categorized by the substance they are made of and thus can be organic or inorganic.

The most commonly used nanoparticles are inorganic nanoparticles, due to their suspendable nature in liquid media. Organic nanoparticles are often soluble in liquid media and hence difficult to handle. Preferred nanoparticles according to the present embodiments are therefore inorganic nanoparticles and organic nanoparticles that are suspendable in liquid media.

Representative examples of suspendable organic nanoparticles include, but are not limited to, nanoparticles of dyes and pigments, whitening agents and the like.

In preferred embodiments of the present invention the nanoparticles being entrapped in the spherical composites described herein are hydrophobic nanoparticles, and more preferably the nanoparticles are hydrophobic nanocrystals.

As mentioned hereinabove, inherently hydrophobic and hydrophobically coated nanocrystals (made hydrophobic by suitable ligands on the exterior surface) constitute a family of nanocrystals which are characterized by high-quality and stability.

Hydrophobic nanoparticle or nanocrystal, according to the present embodiments, can comprise a core of one substance, such as CdSe, and a shell of another substance, such as ZnS.

Thus, in additional embodiments of the present invention, the hydrophobic nanoparticles have a core/shell structure.

In one embodiment, the nanoparticles include a core of a binary semiconductor material, e.g., a core of the formula MX, where M can be cadmium, zinc, mercury, aluminum, lead, tin, gallium, indium, thallium, magnesium, calcium, strontium, barium, copper, and mixtures or alloys thereof and X is sulfur, selenium, tellurium, nitrogen, phosphorus, arsenic, antimony, and mixtures or alloys thereof.

In another embodiment, the nanoparticles include a core of a ternary semiconductor material, e.g., a core of the formula M₁M₂M₃X, where M₁ and M₂ can be cadmium, zinc, mercury, aluminum, lead, tin, gallium, indium, thallium, magnesium, calcium, strontium, barium, copper, and mixtures or alloys thereof and X is sulfur, selenium, tellurium, nitrogen, phosphorus, arsenic, antimony, and mixtures or alloys thereof.

In another embodiment, the nanoparticles include a core of a quaternary semiconductor material, e.g., a core of the formula M₁M₂M₃X, where M₁, M₂ and M₃ can be cadmium, zinc, mercury, aluminum, lead, tin, gallium, indium, thallium, magnesium, calcium, strontium, barium, copper, and mixtures or alloys thereof and X is sulfur, selenium, tellurium, nitrogen, phosphorus, arsenic, antimony, and mixtures or alloys thereof.

In other embodiments, the nanoparticles include a core of a quaternary semiconductor material, e.g., a core of a formula such as M₁X₁X₂, M₁M₂X₁X₂, M₁M₂M₃X₁X₂, M₁X₁X₂X₃, M₁M₂X₁X₂X₃ or M₁M₂M₃X₁X₂X₃, where M₁, M₂ and M₃ can be cadmium, zinc, mercury, aluminum, lead, tin, gallium, indium, thallium, magnesium, calcium, strontium, barium, copper, and mixtures or alloys thereof and X₁, X₂ and X₃ can be sulfur, selenium, tellurium, nitrogen, phosphorus, arsenic, antimony, and mixtures or alloys thereof.

Non-limiting examples of nanoparticles that are suitable for use in the context of the present invention include cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TIAs), thallium nitride (TIN), thallium phosphide (TIP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN) and the like, and any mixtures thereof.

In another embodiment, the nanoparticles include a core of a metallic material such as gold (Au), silver (Ag), cobalt (Co), iron (Fe), nickel (Ni), copper (Cu), manganese (Mn), alloys thereof and any combination of the foregoing.

The nanoparticles entrapped in the spherical composites according to the present embodiments, and particularly nanocrystals, can be further sub-grouped by their properties. Thus, the nanocrystals can be, for example, semiconducting nanocrystals, chromogenic nanoparticles, metallic nanocrystals, magnetic nanocrystals, oxide nanocrystals, fluorescent nanocrystals, luminescent nanocrystals, phosphorescent nanocrystals, optically active nanocrystals and radioactive nanocrystals.

The terms “semiconducting” and “semiconductive”, as used herein, refer to a characteristic of a solid material whose electrical conductivity at room temperature is between that of a conducting element and that of an insulating element. When exposed to heat, electric field or light of discrete wavelength, semiconductive nanoparticles change their electric conductivity from that of a conducting substance to that of an insulating substance and vice versa, depending on the type. In a semiconducting substance there is a limited movement of electrons, depending upon the crystal structure of the material constituting the substance. The incorporation of certain impurities in the lattice of a semiconducting substance enhances its conductive properties. The impurities either add free electrons or create holes (electron deficiencies) in the crystal structures of the host substances by attracting electrons. Thus, there are two types of semiconducting substances: the N-type (negative), in which the current carriers (electrons) are negative, and the P-type (positive), in which the positively charged holes move and carry the current. The process of adding these impurities is called doping; the impurities themselves are called dopants. Dopants that contribute mobile electrons are known as donor impurities; those that cause the formation of holes are known as acceptor impurities. Undoped semiconducting material is called intrinsic semiconductor material. Certain chemical compounds and elements, including, for example, silicone, gallium arsenide, indium antimonide, and aluminum phosphide are semiconducting elements. Semiconducting elements are often used to construct electronic devices such as diodes, transistors, and computer memory devices.

The phrase “magnetic” as used herein refers to a physical characteristic of a substance which exhibits itself by producing a magnetic field, thereby showing an aptitude to attract ferromagnetic substances, such as iron, and align in an external magnetic field. Magnetic nanoparticles in the context of the present invention, are nano-sized magnets, and can be utilized as such in applications which utilize this magnetic characteristic.

The phrase “optically active” as used herein refers to a characteristic of a substance which rotates the plane of incident linearly polarized light. The optically active nanoparticles according to embodiments of the present invention, include nanoparticles that rotate the electric field clockwise (dextrorotatory) and nanoparticles that produce a counterclockwise rotation (levorotatory), and are known as enantiomorphs. The optical activity of nanoparticles is typically associated with the crystal structure thereof, as evidenced by the fact that neither molten nor amorphous nanoparticles demonstrate optical activity.

The term “luminescent” refers to a characteristic of a substance that can emit all forms of cool light, i.e., light emitted by sources other than a hot, incandescent body. Luminescence is a collective term that is used to describe phenomena caused by the movement of electrons within a substance from higher energetic states to lower energetic states. There are many types of luminescence, including chemiluminescence, produced by certain chemical reactions, mainly oxidations, at low temperatures; electroluminescence, produced by electric discharges, which may appear, for example, when silk or fur is stroked or when adhesive surfaces are separated; and triboluminescence, typically produced by rubbing or crushing crystals. When the luminescence is caused by absorption of some form of radiant energy, such as ultraviolet radiation or X rays (or by some other forms of energy, such as mechanical pressure), and ceases as soon as (or very shortly after) the radiation causing it ceases, then it is known as fluorescence. If the luminescence continues after the radiation causing it has stopped, then it is known as phosphorescence.

As used herein, the term “chromogenic” refers to a physical characteristic of a substance that, when interacting with light of multiple wavelengths, discriminately absorbs, transmits and/or reflects light of specific wavelength(s) thus rendering the substance colored when visible and/or when various spectrophotometric measurements are applied. For example, dyes and pigments are chromogenic substances.

Exemplary semiconducting nanocrystals include, without limitation, InAs, CdS, Ge, Si, SiC, Se, CdSe, CdTe, ZnS, ZnSe, CdSe/ZnS or InAs/ZnSe core-shell nanocrystals. Exemplary metallic nanocrystals include, without limitation, Au, Cu, Pt, Ag and PbSe. Exemplary magnetic nanocrystals include, without limitation, Fe₂O₃, Co, Mn and the like.

The nanocrystals entrapped in the spherical composites described herein are dispersed randomly throughout the volume of the spherical composite. In preferred embodiments of the present invention, the nanocrystals impart the resulting composition it's the unique characteristics thereof. The nanocrystals entrapped in the composites can therefore be selected according to the desired application of the resulting composition, while exerting their unique characteristics from within spherical composites.

While reducing the present invention to practice, the present inventors have successfully prepared a variety of spherical composites entrapping semiconducting, metallic, coated and uncoated hydrophobic nanocrystals such as, for example, CdSe nanocrystals, CdSe/ZnS nanocrystals, InAs nanocrystals, InAs/ZnSe nanocrystals, Au nanocrystals and PbSe nanocrystals, as demonstrated and exemplified in the Examples section that follows (see, Table 1 hereinbelow).

Color-tunable microparticles are of great interest for various applications as inks, coatings, labeling and tagging, in optics, catalysis, sensing, in optical microcavities and as building blocks for photonic band-gap structures. As can be seen in, for example, FIG. 5, and exemplified in the Examples section that follows, the characteristic emission pattern of entrapped CdSe/ZnS core/shell semiconducting nanocrystals, covering the visible spectral band, and which is strongly correlated to their size and shape, is preserved and maintained after entrapment in the spherical composites described herein.

The compositions described herein can therefore be utilized, in addition to the provision of protected nanoparticles, to introduce optical, chemical and/or physical functionalities to the entrapping spherical composite, by taking advantage of the wide-range tunable absorption and emission, magnetic and/or radioactive characteristics provided by nanoparticles, and particularly by nanocrystals. Thus, the functional characteristic of the spherical composites of the present embodiments follows that of the nanoparticles, which bestow, for example, semi-conductivity, chromogenic activity, photoelectronic reactivity, optical activity, spectral activity, magnetism and radioactivity on the spherical composites, resulting in, for example, optically active, semi-conductive, chromogenic, magnetic and radioactive spherical composites.

The phase “chromogenic activity” describes phenomena which pertain to chromogenic characteristics of a substance, as these are defined herein. Chromogenic activity may be exhibited by the appearance of colors, typically in the visible range.

The phase “optical activity” refers to phenomena exhibited by optically active substances, as these are defined herein.

The phase “spectral activity” as used herein refers jointly to chromogenic, fluorescent, phosphorescent, luminescent and optical activities, as these are defined herein.

The phase “semi-conductivity” refers to phenomena exhibited by semiconducting substances, as these are defined herein.

The term “radioactivity” as used herein refers to the spontaneous emission of radiation, either directly from unstable atomic nuclei or as a consequence of a nuclear reaction. The radiation emitted by a radioactive substance, includes alpha particles, nucleons, electrons, positrons and gamma rays.

The phase “photoelectronic reactivity” as used herein refers jointly to semiconductivity, spectral activity and the phenomena known as photoelectric effect. The photoelectric effect is expressed by the ejection of electrons from a substance caused by incident electromagnetic radiation, especially by visible light.

The phase “magnetism” refers to phenomena exhibited by magnetic substances, as these are defined herein.

Optically active and semi-conductive spherical composites as presented herein can be efficiently utilized in many applications such as, but not limited to, inks and paints, optical and photo-electronic labeling, optical filtration, electronic paper and barcoded tags.

Magnetic spherical composites as presented herein can be efficiently utilized in applications such as, but not limited to, magnetic liquids, magnetic separation and labeling of various cells, DNA/RNA fragments, proteins, small molecules and the likes.

Radioactive spherical composites as presented herein can be utilized in applications wherein tracing and detection of entities of interest is required, such as, but not limited to, chromatography, diagnostic and therapeutic nuclear medicine and the likes.

These and additional applications of various nanoparticles-entrapping spherical composites as presented herein are detailed hereinbelow.

In the course of designing, practicing and studying the production of the spherical composites described herein, the present inventors have uncovered that the size, size distribution, uniformity, shape, discreteness and other properties of the spherical composites can be finely controlled.

Well-defined and discrete nanoparticles-entrapping spherical composites are highly beneficial in terms of manipulation and the desired application of the composites. The spherical shape is ideal from various points of view, but mostly for the isotropism of emittance from, and absorption of energy into a globular object, and the ability to arrange spheres in tightly packed two-dimensional and three-dimensional lattices, namely, to cover a surface with a uniform film of one or more layers, and to fill in gaps and crevices, or be molded into any other larger shape. Therefore, most applications require a uniform shape and size so as to enable the utilization of predictable and desired chemical and physical characteristics of the composites.

It is further desired that the spherical composites would have a controlled size with an average particle size that typically desirably ranges from tens of nanometers to tens of microns in diameter. This trait is important to the applicability of the spherical composites as fluids, coats and films, in applications such as biolabeling, optical coatings and in optical microcavities, and other applications where the separability, spreadability and rearrangement of the particles must not be retarded.

It is further desired that the spherical composites would be monodispersive, namely, having a narrow size distribution.

Furthermore, it is highly desirable that the spheres would be well-separated and discrete from one another and thus would not form a continuous film.

As is demonstrated in the Examples section that follows, the present inventors have successfully and reproducibly prepared nanoparticles-entrapping spherical composites while gaining a high degree of control over the size, shape, uniformity and discreteness of the spherical composites.

Thus, according to preferred embodiments of the present invention, the spherical composites of the present embodiments have an average size that ranges from about 0.01 μm to about 100 μm in diameter, and preferably from about 0.01 μm to about 10 μm in diameter. More preferably, the average particle size of the spherical composites ranges from about 0.1 μm and about 10 μm in diameter, and even more preferably, the average size e ranges from about 0.2 μm to about 5 μm in diameter.

According to further preferred embodiments of the present invention, the spherical composites are monodispersive, being characterized by advantageously narrow size unimodal distribution thereof. Thus, preferably, at least 60% of the spherical composites have an average size that ranges from about 0.01 μm to about 10 μm in diameter, and more preferably at least 90% of the spherical composites have an average size that ranges from 0.01 μm to about 10 μm in diameter.

According to further preferred embodiments of the present invention, the spherical composites are discrete from one another.

In the course of designing, practicing and studying the production of the spherical composites described herein, the present inventors have uncovered that controlling the desired properties of the spherical composites can be effected by modifying certain parameters during the production process. Thus, as is detailed hereinbelow and is further demonstrated in the Examples section that follows, it was found that properties such as monodispersability and discreteness can be controlled by manipulating parameters such the weight ratio between the hydrophobic polymer and the nanocrystals, the molar/weight ratio between metal oxide or semi-metal oxide and the nanocrystal the and the weight ratio/molar ratio between the hydrophobic polymer and the metal oxide or semi-metal oxide.

In the course of optimizing the conditions at which spherical composites having the desirable properties described hereinabove are obtained, it was found that preferred composites according to the present embodiments are those in which the weight ratio between the hydrophobic polymer and the nanoparticles in the spherical composites ranges from about 1:10 to about 5:1, and preferably from about 1:2 to about 3:1.

It was found that preferred composites according to the present embodiments are those in which the weight ratio of the metal oxide or semi-metal oxide and the hydrophobic polymer ranges from about 2:1 and about 50:1, and preferably from about 5:1 and about 20:1.

In addition to granting protection and a suitable form for handling and utilization of nanoparticles, the sol-gel derived entrapping matrix enables the indirect conjugation of nanoparticles to a wide variety of functionalizing moieties, by virtue of chemical groups that are attached to the spherical composites.

Thus, according to embodiments of the present invention, the spherical composites presented herein further include one or more functionalizing group attached thereto.

The phrase “functionalizing group” as used herein refers to a moiety which imparts a certain functionality to the entity it is attached to or which enables the provision of a certain functionality to the entity by means of increasing its reactivity toward a functional moiety.

The functionalizing group is preferably attached to the outer portion of the spheres.

As used herein, the terms “functional”, “functionality” and grammatical diversions thereof refer to a characteristic that can be utilized in certain applications and/or that allows an entity (e.g., group, moiety, composite, composition) to be utilized in certain application. By “applications” in this context of the present invention it is meant, for example, chemical interactions, physical interactions, mechanical overreactions, pharmacological interactions, optical interactions, spectral interactions and the like.

Exemplary functionalizing groups that can be attached to the spherical composites described herein can be categorized as chemical moieties and biological moieties, as defined detailed hereinunder.

As used herein, the phrase “chemical moiety” describes a moiety, typically a chemical group, that provides the composite with a chemical functionality such as, for example, suspendability, dispersability, reactivity, partial or full electrical charge, radioactivity, hydrophobicity and the likes.

Chemical moieties that impart reactivity to the composite typically include chemically reactive groups.

The phrase “chemically reactive group” as used herein describes a chemical group that is capable of undergoing a chemical reaction that typically leads to a bond formation. The bond can be a covalent bond, a ionic bond, a hydrogen bond and the like. Chemical reactions that lead to a bond formation include, for example, nucleophilic and electrophilic substitutions, nucleophilic and electrophilic addition reactions, elimination reactions, cycloaddition reactions, rearrangement reactions, aromatic interactions, hydrophobic interactions, electrostatic interactions and any other known reactions that result in an interaction between two or more components. Attachment of chemically reactive groups to the composites can therefore enable the attachment, by various interactions and/or bonds, of any desired moiety to the composites, via a chemical reaction.

Chemical moieties that impart suspendability or dispersability to the composite typically include charged groups, namely, positively charged and/or negatively charged groups. Examples of such chemical moieties include, but are not limited to, negatively charged groups such as sulfones, sulfonates, phosphates and the likes.

Additional chemical moieties that impart dispersability to the composites include chemical groups that can interact with a dispersing medium. Exemplary of such chemical moieties include, but are not limited to, silylating groups that can interact with polymers that contain for example hydroxy groups and thus form a dispersion of the spherical composites within the polymer.

Chemical moieties that impart radioactivity to the spherical composites include chemical groups that include one or more radioactive isotopes.

Chemical moieties that impart electrical charge to the spherical composites can be used to render the composites suspendable in liquid media, as mentioned hereinabove, and/or can provide the composite with characteristics such as membrane permeability. Examples of such chemical moieties include, for example, positively charged groups such as amines, guanidines, and the likes.

Chemical moieties that impart hydrophobicity to the spherical composites include, for example, long chain alkyls, alkenyls, aryls and combinations thereof.

Representative examples of chemical moieties that can be attached to the spherical composites described herein include, without limitation, amine, alkoxy, aryloxy, azo, C-amide, carbamate, carboxylate, cyano, guanidine, guanyl, halide, hydrazine, hydroxy, N-amide, nitro, phosphate, phosphonate, silyl, sulfinyl, sulfonamide, sulfonate, thioalkoxy, thioaryloxy, thiocarbamate, thiohydroxy, thiourea and urea, as these terms are defined hereinafter, as well as oxirane (epoxy), N-hydroxysuccinimide (NHS), nitrilotriacetic acid (NTA) and ethylenediaminetetracetic acid (versine, EDTA), whereby these groups can be charged or non-charged and can further include one or more radioisotopes.

As used herein, the term “amine” refers to a —NR′R″ group, wherein R′ and R″ are each independently hydrogen, alkyl, cycloalkyl, aryl, as these terms are defined hereinbelow.

The term “alkyl” refers to a saturated aliphatic hydrocarbon including straight chain and branched chain groups. Preferably, the alkyl group has 1 to 20 carbon atoms. The alkyl group may be substituted or unsubstituted. When substituted, the substituent group can be, for example, hydroxyalkyl, trihaloalkyl, cycloalkyl, alkenyl, alkynyl, aryl, heteroaryl, heteroalicyclic, amine, halide, sulfonate, sulfinyl, phosphonate, phosphate, hydroxy, alkoxy, aryloxy, thiohydroxy, thioalkoxy, thioaryloxy, cyano, nitro, azo, sulfonamide, carboxylate, thiocarbamate, urea, thiourea, carbamate, C-amide, N-amide, guanyl, guanidine and hydrazine.

The term “cycloalkyl” refers to an all-carbon monocyclic or fused ring (i.e., rings which share an adjacent pair of carbon atoms) group where one or more of the rings does not have a completely conjugated pi-electron system. The cycloalkyl group may be substituted or unsubstituted. When substituted, the substituent group can be, for example, hydroxyalkyl, trihaloalkyl, cycloalkyl, alkenyl, alkynyl, aryl, heteroaryl, heteroalicyclic, amine, halide, sulfonate, sulfinyl, phosphonate, phosphate, hydroxy, alkoxy, aryloxy, thiohydroxy, thioalkoxy, thioaryloxy, cyano, nitro, azo, sulfonamide, carboxylate, thiocarbamate, urea, thiourea, carbamate, C-amide, N-amide, guanyl, guanidine and hydrazine.

The term “aryl” refers to an all-carbon monocyclic or fused-ring polycyclic (i.e., rings which share adjacent pairs of carbon atoms) groups having a completely conjugated pi-electron system. The aryl group may be substituted or unsubstituted. When substituted, the substituent group can be, for example, hydroxyalkyl, trihaloalkyl, cycloalkyl, alkenyl, alkynyl, aryl, heteroaryl, heteroalicyclic, amine, halide, sulfonate, sulfinyl, phosphonate, phosphate, hydroxy, alkoxy, aryloxy, thiohydroxy, thioalkoxy, thioaryloxy, cyano, nitro, azo, sulfonamide, carboxylate, thiocarbamate, urea, thiourea, carbamate, C-amide, N-amide, guanyl, guanidine and hydrazine.

The term “alkoxy” refers to both an —O-alkyl and an —O-cycloalkyl group, as defined herein.

The term “C-amide” refers to a —C(═O)—NR′R″ group, where R′ and R″ are as defined herein.

The term “N-amide” refers to a R′C(═O)—NR″— group, where R′ and R″ are as defined herein.

The term “aryloxy” refers to both an —O-aryl and an —O-heteroaryl group, as defined herein.

The term “azo” refers to a —N═NR′ group, with R′ as defined hereinabove.

The term “carbamate” refers to a —OC(═O)—NR′R″ for O-carbamate group, and to a to R″OC(═O)—NR′— for N-carbamate group, with R′ and R″ as defined herein.

The term “carboxylate” refers to a —C(═O)—OR′ group, where R′ is as defined herein.

The term “cyano” refers to a —C≡N group.

The term “guanyl” refers to a R′R″ NC(═N)— group, where R′ and R″ are as defined herein.

The term “guanidine” refers to a —R′NC(═N)—NR″R′″ group, where R′ and R″ are as defined herein and R′″ is defined as either R′ or R″.

The term “halide” group refers to fluorine, chlorine, bromine or iodine.

The term “hydrazine” refers to a —NR′—NR″R′″ group, with R′, R″ and R′″ as defined herein.

The term “hydroxy” refers to a —OH group.

The term “nitro” refers to an —NO₂ group.

The term “phosphate” describes a —O—P(═O)(OR′)(OR″) group, with R′ and R″ as defined herein.

The term “phosphonate” describes a —P(═O)(OR′)(OR″) group, with R′ and R″ as defined herein.

The term “silyl” refers to an —SiR′R″R′″ group, where R′, R″ and R′″ as defined herein, or, alternatively, at least one of R′, R″ and R′″ is alkoxy, aryloxy, amine, hydroxy, thiohydroxy or halide.

The term “sulfonate” refers to an —S(═O)₂—R′ group, where R′ is as defined herein.

The term “sulfonamide” refers to an —S(═O)₂—NR′R″ for S-sulfonamide group, and to an —NR′S(═O)₂—R″ for N-sulfonamide group, with R′ and R″ as defined herein.

The term “sulfinyl” refers to a —S(═O)—R′ group, where R′ is as defined herein.

The term “sulfone” refers to an —S(═O)₂—OR′ group, where R′ is as defined herein.

The term “thiocarbamate” refers to an —SC(═O)—NR′R″ for O-thiocarbamate group, and to an R′SC(═O)NR′— for N-thiocarbamate group, with R′ and R″ as defined herein.

The term “thiourea” and/or “thioureido” refers to a —NR′—C(═S)—NR′R′″ group, with R′, R″ and R′″ as defined herein.

The term “thiohydroxy” refers to an —SH group

The term “thioalkoxy” refers to both an —S-alkyl group, and an —S-cycloalkyl group, as defined herein.

The term “thioaryloxy” refers to both an —S-aryl and an —S-heteroaryl group, as defined herein.

The term “urea” and/or “ureido” refers to a —NR′C(═O)—NR″R′″ group, where R′ and R″ are as defined herein and R′″ is defined as either R′ or R″.

The chemical moieties on the surface of the spherical composites presented herein, may by further modified to other forms of chemical moieties. The chemical moieties per se bestow functionality to the spherical composites, such as, for example, charged chemical moieties that assist in suspending the spherical composites in liquid media such as used in microfluidic devices, and other reactive groups which render the spherical composites susceptible to chemical reactions leading to binding to various materials and objects, as in the specific case of bioactive agents.

As used herein, the phrase “bioactive moiety” describes a molecule, compound, complex, adduct and/or composite that exerts one or more biological and/or pharmacological activities.

Attachment of a bioactive moiety via a chemical moiety to the surface of the spherical composites presented herein will render the composite microspheres suitable for applications such as, for example, molecular targeting, imaging techniques, immunological research, separation and purification of cells, nucleic acids and proteins, DNA chips, miniaturized biosensors used in biomedical research, gene expression profiling, drug discovery, and clinical diagnostics.

Representative examples of bioactive moieties that can be beneficially attached to the spherical composites described herein include, without limitation, proteins, agonists, amino acids, antagonists, anti histamines, antibiotics, antibodies, antigens, antidepressants, anti-hypertensive agents, anti-inflammatory agents, antioxidants, anti-proliferative agents, antisense, anti-viral agents, chemotherapeutic agents, co-factors, fatty acids, growth factors, haptens, hormones, inhibitors, ligands, DNA, RNA, oligonucleotides, labeled oligonucleotides, nucleic acid constructs, peptides, polypeptides, enzymes, saccharides, polysaccharides, radioisotopes, radiopharmaceuticals, steroids, toxins, vitamins, viruses, cells and combinations thereof. The bioactive moiety can further include biotinylated derivatives of the above.

The functionalizing group can be introduced to the spherical composite via reactive groups that form a part of the sol-gel oxide and/or the hydrophobic polymer. The presence and nature of such reactive groups can be determined by the sol-gel precursor and/or the polymer used to construct the spherical composite. Alternatively, the sol-gel precursor and/or the hydrophobic polymer can be selected so as to include the functionalizing group, such that the resulting composites inherently have these functionalizing groups attached thereto.

Examples of sol-gel precursor that include a functionalizing group include modified sol-gel precursors, in which one of the substituents on the metal or semi-metal atom includes a functionalizing group. The functionalizing group can be attached to the metal or semi-metal atom either directly or via a spacer (e.g., alkyl).

Thus, functionalizing chemical moieties on the surface of the spherical composites may stem from chemical moieties which form a part of the sol-gel metal-oxide precursor and/or semi-metal oxide precursor, from chemical moieties which form a part of an organically modified sol-gel precursor, and/or from chemical moieties which form a part of the hydrophobic polymer. Alternatively, functionalizing chemical moieties can be introduced onto the surface of the spherical composites presented herein after these have been formed, by altering and modifying inherently-existing groups on the surface, stemming from the abovementioned components of the composites.

The ability to further functionalize the spherical composites presented herein with a variety of functionalizing groups broadens the scope of applications and uses of the spherical composites. Thus such functionalized nanoparticles-entrapping spherical composites can serve, for example, as targeting systems, suspendable agents, fillers and lubricants, imaging probes, as tagging and labeling agents, in isolation and purification of biological molecules via magnetic and affinity chromatography, in affinity pairs coupling, in immunohistochemical staining, for introducing multiple labels into tissues, for localizing hormone binding sites, in flow cytometry, in in situ localization and hybridization, radio-, enzyme-, and fluorescent immunoassays, as neuronal tracers, in genetic mapping, in hybridoma screening, in purification of cell surface antigens, for coupling antibodies and antigens to solid supports, and for examination of membrane vesicle orientation.

As mentioned hereinabove, the present inventors have designed a process for the successful and reproducible production of the nanoparticles-entrapping spherical composites described herein. This process is a sol-gel derived process and hence enjoys the advantages associated with such a process, namely, cost effectiveness, highly-controlled parameters, mild and non-harmful conditions and many more.

The growth of metal oxide chains and networks during the sol-gel process allows full control over the chemical polymerization and gelation at mild and moderate conditions, which offer great benefits from the aspect of maintaining the integrity of the entrapped entities, and more so from the industrial and environmental aspects. Control of chemical polymerization, such as the acid and base catalyzed hydrolysis of sol-gel precursors in alcoholic solutions, allows control of the form of the resulting polymer. The sol-gel process, being so widely practiced and well studied, is therefore exceptionally suitable for adaptation for the preparation of spherical nanoparticles entrapping composites.

The process was further designed and optimized so as to allow controlling the size of the spherical composites and to achieve a narrow size distribution thereof. As mentioned hereinabove, such size control is important for applications such as bio-labeling, optical coatings, as well as for optical microcavities [Cha, J. N. et al., Nano Lett., 2003, 3, 907].

Hence, according to another aspect of the present invention there is provided a process of preparing spherical composites, wherein each spherical composite comprises at least one sol-gel metal oxide or semi-metal oxide and at least one hydrophobic polymer, and further wherein at least one of these spherical composites comprises at least one nanoparticle entrapped therein.

The process, according to this aspect of the present invention, is effected by mixing a hydrophobic solution which comprises at least one sol-gel precursor, as described herein, at least one hydrophobic polymer as described herein and at least one type of a nanoparticle as described herein, with a hydrophilic solution, to thereby obtain a mixture containing a plurality of the spherical composites.

According to preferred embodiments of this aspect of the present invention, the hydrophobic solution further comprises a hydrophobic solvent such as, for example, chloroform, dichloromethane, carbon tetrachloride, methylene chloride, xylene, benzene, toluene, hexane, cyclohexane, diethyl ether and carbon disulfide. Preferably the organic solvent is toluene, which is immiscible with water, and suitable for dissolving the preferred sol-gel precursor and hydrophobic polymer mentioned above.

According to further preferred embodiments of this aspect of the present invention, the hydrophilic solution further comprises a hydrophilic solvent such as, for example, methanol, ethanol, acetonitrile and the likes. Preferably the hydrophilic solvent is ethanol.

It is well established in the art that the sol-gel process receives its high degree of controllability by virtue of additional factors, such as the catalyst used for the hydrolysis of the sol-gel precursor (e.g., an acid or base catalyst), and the addition of a surfactant, which increases the reactivity cross-section of the metal oxide or semi-metal oxide and the precursor and further influences the interfacial properties during the formation of the spheres.

Hence, preferably, the hydrophilic solution further comprises a catalyst, and, more preferably, a base catalyst such as ammonium hydroxide. However, it should be appreciated that any other base or acid catalysts can be utilized.

Further preferably, the hydrophilic solution further comprises one or more surfactants. The surfactant was found to have a critical effect on the formation of silica/polystyrene microspheres, as discussed by Sertchook, H. and Avnir, D. (one of the present inventors), in Chem. Mater., 2003, 15, 1690-1694

As used herein, the term “surfactant” describes a substance that is capable of modifying the interfacial tension of the liquid in which it is dissolved.

Surfactants which are suitable for use in the preparation of the spherical composites according to the present embodiments can be anionic, nonionic, amphoteric, cationic or zwitterionic surface-active agents.

Representative examples of surfactants that are suitable for use in this context of the present invention include, without limitation, Tween 80, Triton X-100, sodium dodecyl sulfate (SDS), and cetyltrimethylammonium bromide (CTAB).

As demonstrated in the Examples section that follows and is further discussed hereinabove, the size and discreteness of the spherical composites presented herein can be governed by quantity ratios between the three main reactants in the process, namely the relative amount of the hydrophobic polymer, the relative amount of the nanoparticles and the relative amount of the sol-gel precursor. As exemplified in Example 1 in the Examples section that follows (see, for example, Table 1), the average size, the size distribution, the shape and the discreteness of the spherical composites is reproducibly influenced by these three parameters. These properties, however, were found to be further influenced by other parameters such as the type, size and shape of the nanoparticles, the pH of the reaction and the energy input and duration of the mixing procedure.

Hence, according to preferred embodiments of the present invention, the weight ratio of the hydrophobic polymer and the nanoparticles in the hydrophobic solution ranges from about 1:10 to about 5:1, and preferably from about 1:2 to about 3:1.

Accordingly, the concentration ratio of the hydrophobic polymer and the sol-gel precursor in the hydrophobic solution preferably ranges from about 10 mg of the polymer per 1 ml of the sol-gel precursor and about 100 mg of the polymer per 1 ml of the sol-gel precursor, and more preferably from about 30 mg of the polymer per 1 ml of the sol-gel precursor and about 70 mg of the polymer per 1 ml of the sol-gel precursor.

Further, the concentration ratio of the sol-gel precursor and the nanoparticles in the hydrophobic solution ranges from about 10 mg of the nanoparticles per 1 ml of the sol-gel precursor and about 50 mg of the nanoparticles per 1 ml of the sol-gel precursor.

Once the reaction is complete, virtually all the sol-gel precursor is consumed and the spherical composites are obtained as the only solids in the reaction mixture. Therefore, the process of obtaining the spherical composites of the present invention further includes isolation of the microspheres by filtration and/or evaporation of the residual solvents.

As discussed hereinabove, the spherical composites of the present invention are highly suitable to serve to functionalize a surface of a compound, a cell or any other article, and thereby bestow the unique spectral, magnetic and radioactive characteristics and other effects which originate from the nanoparticles which are entrapped therein.

The spherical composites presented herein may be utilized to form a functional thin layer. Thus, according to another aspect of the present invention, there is provided a functional thin layer comprising the composition which includes the nanoparticles-entrapping spherical composites presented herein.

The functional thin layer may be formed by the spherical composites, namely, the composites serve as building blocks constructing the thin layer. Such functional thin layers can be applied on the surface of various substrates, by means of e.g., dip coating or spin-coating, and serve as, for example, optical coating, optical filter, colored coating, semi-conductive coating and the likes.

Alternatively the functional thin layer can be formed by embedding the spherical composites in, for example, a filmed matrix.

The spherical composites described herein can be further incorporated in various articles-of-manufacture.

Hence, according to yet another aspect of the present invention, there is provided an article-of-manufacture which comprises the composition of the spherical composites as presented herein.

The article-of-manufacture can be any device or material in which the characteristics exhibited by the nanoparticles and hence by the spherical composites, either per se or by virtue of one or more functionalizing groups, can be beneficially exploited in a certain application.

Exemplary such articles-of-manufacture include, without limitation, affinity labeling systems, array sensors, barcoded tags and labels, chromogenic/radio/fluorescent systems for immunoassays, optical amplifiers, electronic papers, fillers and lubricants, light emitting diodes, solid state lighting structures, optical memory devices, dynamic holography devices, optical information processing systems, optical switching devices, solid state lasers, flow cytometry systems, genetic mapping systems, imaging probes, immunohistochemical staining agents, in vivo, in situ and in vitro screening, tracing, localizing and hybridization probes, ink compositions, magnetic and affinity chromatography agents, magnetic liquids, paints, optical filters, optical cavity resonators, photonic band-gap structures, suspending systems and targeting systems.

Marking and labeling of various surfaces with machine-readable symbols is a well used and rapidly developing technology. This technology includes cryptic marking, invisible to the human eye and undetectable by other optical techniques. An ink based on physical characteristics, such as photoelectronic response in unique wavelength ranges, or based on magnetic and semiconducting characteristics, can be used to label surfaces with machine readable markings, which may also be invisible to almost any other means of detection. Thus, according to embodiments of the present invention, the spherical composites presented herein, having photoelectronic, chromogenic, magnetic and/or semiconducting nanoparticles entrapped therein, can be used to prepare special inks, paints and dyes, suitable for automatic and mechanized recognition and reading, such as barcode tags, and for encrypted uses and purposes.

Books with printed pages are unique in that they embody the simultaneous, high-resolution display of hundreds of pages of information. The representation of information on a large number of physical pages, which may be physically turned and written on, constitutes a highly preferred means of information interaction. However, one obvious disadvantage of the printed page, is its immutability once typeset. Thus, according to embodiments of the present invention, the spherical composites presented herein, having photoelectronic, chromogenic and/or semiconducting nanoparticles entrapped therein, can be used to construct electronically addressable paper-page contrast media displays based on real paper or other substrates using multi-layer logic.

The development of photonic crystals, which are basically structures with band gaps that prevent the propagation of light in a certain frequency range, has led to proposals of many novel devices for important applications in lasers, opto-electronics, and communications. Among these devices are high-Q optical filters, waveguides permitting tight bends with low losses, channel-drop filters, efficient LEDs, and enhanced lasing cavities. All of these applications and devices can use glass-entrapped photonic nanocrystals which allow confinement of light in three dimensions, wherein the length scale of the features in a structure must be on the order of microns in order to control light of wavelengths typical in opto-electronics and other applications. Thus, according to embodiments of the present invention, the spherical composites presented herein, having photoelectronic and/or semiconducting nanocrystals entrapped therein, can be used to construct photonic band-gap structures.

Lubricants and fillers made from hard and smooth microspheres are well known in the art. The spherical composites presented herein can be designed so as to exhibit characteristics which will render them suitable as particles in lubricant and fillers, by use of specific sol-gel precursors (such as to titanium oxide) and polymers (such as Teflon).

The spherical composites can be designed to include suitable surface functionalizing groups, or be further functionalized after production so as to have chemical moieties, such as charged chemical moieties on their surface, which will render the spherical composites more suspendable and/or dispersible in liquid media.

Optical amplifiers are key components in long distance telecommunication networks and cable television distribution systems using fiber-optic circuitry. Spherical composites entrapping semiconducting nanoparticles may provide larger fiber bandwidth than presently available with erbium-doped optical fiber amplifiers. By controlling the size distribution of selected semiconducting nanoparticles such as PbSe, the spectral width, position and profile of the particles may be tailored to expand the bandwidths. Further, PbSe colloidal nanoparticles can be excited by a variety of different wavelengths, minimizing the costs associated with systems wherein excitation is limited to a single wavelength.

The spherical composites presented herein may also be useful as phosphorescent materials for use in, e.g., light emitting diodes and solid state lighting structures. The processability of the sol-gel solutions and the photostability of the resultant nanoparticles entrapping spherical composites allow for their use as the active medium in optical devices including optical memory devices. These types of solid composites can have application as the active medium in dynamic holography devices used in optical communications and optical information processing. For example, all-optical switching and optical image correlation may be facilitated by solid composites of the present invention. Also, the spherical composites can be the active media in solid state lasers.

Affinity pairs serve as a basis for the development of many fundamental research endeavors, industrial tools and techniques in fields such as chemistry, biology and medicine. One example of an affinity pair which is presently the most utilized is the Avidin-Biotin affinity pair. In general, affinity pairs having one or more bioactive agents attached thereto, optionally in combination with another functional moiety, can be used, for example, for labeling and tagging of bioactive agents, separation techniques such as affinity chromatography, drug delivery and bioactivity screening. In the context of the present invention, functionalized spherical composites presented herein can be used as labeling moieties which can be a detectable moiety or a probe when attached to a single or a plurality of various molecules such as bioactive agents, and includes, for example, chromogenic and semiconducting nanoparticles, fluorescent nanoparticles, phosphorescent nanoparticles, metallic nanoparticles, radioactive nanoparticles, magnetic nanoparticles, as well as any other known detectable nanoparticles. Thus, according to embodiments of the present invention, the spherical composites presented herein, having detectable nanoparticles entrapped therein, can be used for labeling and tagging molecules such as bioactive agents indirectly as a part of an affinity-pair system. The indirect labeling is effected via an affinity pair wherein one part of the affinity pair is attached to a detectable spherical composite as presented herein, and the second part of the affinity pair is attached to the molecule of interest.

The ever-growing use and requirement of advanced separation techniques grow more and more important in biotechnological research and industry. There is a great need for cost effective, reproducible and automatable methods to handle isolated cells, bacteria, DNA/RNA fragments, proteins, small molecules and the likes. Hence spherical composites as presented herein, entrapping paramagnetic nanoparticles can be used for magnetic separation and purification techniques. The separation and purification technique, according to this embodiment, can be performed, for example, by attaching a spherical composite entrapping paramagnetic nanoparticles as presented herein, to the molecule or bioactive agent to be separated, and apply a magnetic separation technique thereon.

In another exemplary embodiment of an article-of-manufacture according to the present invention, a functionalized spherical composite is used in immunohistochemical staining. As is well known in the art, a key to successful identification of proteins in tissues and other samples by immunohistochemical staining involves careful selection of the protein-specific antibody and an efficient coupling of the antibody to a detectable agent, such as an agent that can be converted to a pigment (chromogenic). An immunohistochemical staining, according to this embodiment, can be performed, for example, by attaching a spherical composite entrapping optically active, chromogenic or otherwise detectable nanoparticles as presented herein, to the specifically desired antibody to thereby provide a detectable spherical composite attached to a specific antibody which can be beneficially used for immunohistochemical staining.

In another exemplary embodiment of an article-of-manufacture according to the present invention, a functionalized spherical composite is used in flow cytometry. As a well established technique, flow cytometry involves the use of a beam of laser light projected through a liquid stream that contains cells, or other particles, which when subjected to the focused light emit detectable signals. These signals are then converted for computer storage and data analysis, and can provide information about various cellular properties. In order to make the measurement of biophysical or biochemical properties of interest possible, the cells are usually stained with a fluorescent agent that binds specifically to specific cellular constituents. The fluorescent agent is excited by the laser beam, and emits light at a different wavelength. A flow cytometry experiment, according to this embodiment, can be performed, for example, by conjugating a spherical composite, entrapping fluorescent nanoparticles as presented herein, to specific cellular constituents to thereby provide a fluorescent spherical composite attached to a certain type of cells.

In yet another exemplary embodiment of an article-of-manufacture according to the present invention, a functionalized spherical composite is used in fluorescence in situ hybridization (FISH). FISH is a method of localizing, either mRNA within the cytoplasm or DNA within the chromosomes of the nucleus, by hybridizing the sequence of interest to a complimentary strand of a nucleotide probe labeled with a fluorescent agent. The method is also called chromosome painting. The sensitivity of the technique is such that threshold levels of detection are in the region of 10-20 copies of mRNA or DNA per cell. Probes are complimentary sequences of nucleotide bases to the specific RNA or DNA sequence of interested. These probes can be as small as 20-40 base pairs, up to a 1000 base pairs. Types of probes can be oligonucleotide, single or double stranded DNA and RNA strands which are labeled with a fluorescent agent. A FISH procedure, according to this embodiment, can be performed, for example, by conjugating a spherical composite, entrapping fluorescent nanoparticles as presented herein, to a nucleotide probe to thereby provide a fluorescent spherical composite attached to a nucleotide probe.

Similarly to the immunohistochemical staining, flow cytometry and fluorescence in situ hybridization, other molecules, such as bioactive agents and drugs can be directly and indirectly (via an affinity pair) labeled by one or more detectable spherical composites, or vice versa, one or more molecules can be attached to a detectable spherical composite. Such labeled and tagged molecules can be used as affinity labeling agents, genetic mapping agents, imaging agents, screening and localization agents and chromatography agents.

In a further embodiment of this aspect of the present invention, the article-of-manufacture is a magnetic liquid. A magnetic liquid consists of a carrier liquid and small magnetic particles held in suspension by a surface active layer effected by a surfactant. Carrier liquids are selected to meet the needs of particular applications with frequently used liquids just as hydrocarbon oils. According to this embodiment, spherical composites entrapping magnetic nanoparticles stabilized in suspension in the carrier fluid under all conditions by virtue of functionalizing groups which assist in suspendability. Such a magnetic liquid can be held in place against forces, such as gravity, by a magnetic field often produced by a permanent magnet. Typical uses of magnetic liquids include rotating shaft seal in high vacuum, gas, dust and mist systems; a damper and heat transfer devices in which the viscosity increases in magnetic field (such as in powerful loudspeakers); sink-and-float separation by changing the fluid's buoyancy with a magnetic field; magneto-optic devices wherein fluids' birefringence according to a magnetic field as in LCD (liquid crystal display).

The spherical composite presented herein, entrapping chromogenic nanoparticles, can be further used as a solid pigment in paint, suspended with a binding medium, typically thinned with a solvent to form a liquid vehicle. Preferably, the entrapping matrix of spherical composite used in paint is functionalized so as to assist in suspending the spherical composite in the paint's liquid vehicle. Paints made with the spherical composites presented herein may be used to create special effects such as glow, brilliance, radiance, glare, glisten, glitter and effulgence.

The spherical composites presented herein, entrapping optically active, metallic and other nanoparticles can be further used in optical and radiation filters when applied as a layer onto a filter carrier, such as a sheet of glass or plexiglass. When entrapping optically active nanoparticles, such filters can be used as polarizers; when entrapping chromogenic nanoparticles, such filters can be used as to block light of certain wavelength; and when entrapping metallic nanoparticles, as radioactive filter/screen.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Materials and Experimental Methods

Reagents for the Preparation of Nanocrystals:

Tri-n-butylphosphine (TBP, 99%) was obtained from Strem

Dimethylcadmium (Cd(CH₃)₂) was obtained from Strem, transferred from its original container under vacuum to remove impurities and stored in a refrigerator inside a glovebox.

Tetradecylphosphonic acid (TDPA) was obtained from Alfa.

Hexylphosphonic dichloride (C₆H₁₃CI₂PO, 95%) was obtained from Aldrich.

Trioctylphosphine (TOP, 90%) was obtained from Aldrich, purified by vacuum distillation and kept in the glovebox.

Trioctylphosphine oxide (TOPO, 90% purity) was obtained from Aldrich.

Selenium (Se), indium trichloride (InCl₃) was obtained from Aldrich.

Tris(tri-methylsilyl) arsenide ((TMS)₃As) was obtained from Aldrich and handled as detailed by Becker, G. et al. in Anorg. Allg. Chem., 1980, 462, 113.

Hexamethyldislthiane ((TMS)₂S) was obtained from Aldrich.

Diethylzinc (Zn(CH3)₂) was obtained from Aldrich and dissolved in hexane at 1 M concentration.

Hydrogen terachloroaurate trigydrate (HAuCl₄:3H₂O) was obtained from Aldrich.

1-Dodecanthiol (lauryl mercaptan), C₁₂H₂₅SH, 98%) was obtained from Aldrich.

Sodium borohydride, (NaBH₄, 95%) was obtained from Aldrich.

Tetraoctylammonium bromide (N(C₈H₁7)₄Br, 98%) was obtained from Aldrich.

Hexylphosphonic acid (HPA) was prepared by reacting hexylphosphonic dichloride with water followed by an extraction with diethyl ether and isolation by evaporation of the ether.

Reagents for the Preparation of Composite Microspheres:

Polystyrene monohydroxy-terminated (PS-10000, MW 10,000) was purchased from Scientific Polymer Products.

Tetraethoxysiliane (TEOS) was obtained from Aldrich.

Tween 80 (cat. No. 27, 436-4) was obtained from Aldrich.

Particles Characterization:

Electron microscopy and fluorescence microscopy images of a single nanocrystal-entrapping composite microsphere were measured as described by Ebenstein, Y. et al. in Appl. Phys. Lett., 2002, 80, 4033. All optical studies were carried out under ambient conditions.

Low-resolution transmission electron microscopy (TEM) images were obtained using a Phillips Tecnai 12 microscope operated at 120 kV. Samples were prepared by depositing a drop of ethanol solution with the composite particles onto a copper grid supporting a thin film of either amorphous carbon or carbon/formvar. The excess liquid was removed with filter paper wicks, and the grid was dried in air.

Low-resolution scanning electron microscopy (SEM) images were taken by analytical Quanta 200 ESEM of FEI.

Energy dispersive X-ray spectroscopy (EDS) analyses were conducted on a JEOL-JAX 8600 Superprobe. Samples were deposited on a graphite substrate.

Fluorescence spectra were recorded using a spectrometer/CCD device (StellarNet model EPP2000). Films of nanocrystals-entrapping spheres were prepared by dispersing the spheres on the glass substrate, and the emission was detected at right angle (90°) in the detection of the monochromator, using a photomultiplier (PMT). All fluorescence measurements were conducted using a 473 nm laser line for excitation.

### Example 1

### Preparation and Characterization of Sol-Gel/Polymer Composite Microspheres Entrapping Nanocrystals

### Chemical Syntheses

Preparation of Nanocrystals:

Semiconducting nanocrystals that can impart optical functionality to the composite spheres were selected as exemplary nanocrystals for entrapment in the composites, taking advantage of the widely tunable band gap absorption and emission exhibited by the nanocrystals.

All nanocrystals were prepared, and/or coated with organic ligands, according to published procedures as follows:

CdSe nanocrystalline dots were prepared as described by Murray, C. B. et al. in J. Am. Chem. Soc., 1993, 115, 8706-8715.

CdSe/ZnS (core/shell, CS) nanocrystalline dots were prepared as described by Dabbousi, B. O. et al. in J. Phys. Chem., 1997, 8, 101, 9463-9475 and by Talapin, D. V. et al. in Nano Lett., 2001, 1, 207-211.

CdSe nanocrystalline rods were prepared as described by Peng, Z. A. and Peng, X. in J. Am. Chem. Soc., 2001, 123, 1389-1395 and by Manna, L. et al. in J. Am. Chem. Soc., 2000, 122, 12700-12706.

CdSe/ZnS core/shell nanocrystalline rods were prepared as described by Mokari, T. and Banin, U. in Chem. Mater., 2003, 15, 3955.

InAs nanocrystalline dots were prepared as described by Guzelian, A. A. et al. in Appl. Phys. Lett., 1996, 69, 432.

InAs/ZnSe core/shell nanocrystalline dots and Au nanocrystals were prepared as described by Cao Y. W. and Banin, U. in J. Am. Chem. Soc., 2000, 122, 9692.

Preparation of Sol-Gel/Polymer Composite Microspheres Entrapping Nanocrystals—General Procedure:

A process of preparing well-defined and separated microspheres (as opposed to connected spheres, which typically form a continuous film) in which hydrophobic nanocrystals are entrapped was designed and practiced as follows.

The process utilizes the composite nature of the sol-gel silica particles, combined with the polystyrene component which provided an hydrophobic environment that enabled the entrapment of the nanocrystals within separated spheres.

The process was optimized to the extent that mono-dispersed spheres could be obtained reproducibly.

The process for the entrapment of nanocrystals presented herein is based on the preparation of silica-polystyrene composite microspheres, as described by Petrovicova, E. et al. in J. Appl. Polm. Sci., 2000, 77, 1684-99; by Mousa, W. F. et al. in J. Bio. Mater. Res., 1999, 47, 336; by Brechet, Y. J. et al. in Adv. Eng. Mater., 2001, 3, 571-577; and by Bokobza, L. et al. in Chem. Mater., 2002, 14, 162-167.

In a typical example, ethanol (12.5 ml), aqueous ammonium hydroxide (2.5 ml, 25% by volume) and Tween80 (0.5 ml) were mixed in a 100 ml flask to give a hydrophilic solution.

In parallel, a solution of coated (hydrophobic) nanocrystals (NC, 20 mg to 60 mg) in toluene (1.0 ml), TEOS (1.0 ml) and various amounts of polystyrene (PS, 20-150 mg), was prepared in a separate vial to give a hydrophobic solution.

The hydrophobic solution was added to the hydrophilic solution at once and the resulting mixture was vigorously stirred overnight. In the course of experimentation, the present inventors have found that an optimal time period for the stirring is 5 to 7 hours. During this time period, a pH of 10.5-11.5 was maintained by controlling the concentration of the sol-gel poly-condensation catalyst, in order to achieve a narrow microsphere size distribution.

The formed spheres were then subjected to centrifugation for 5 minutes followed by removal of the solvent under reduced pressure.

Some samples were subjected to sonication for 30 minutes prior to removal of the solvents, so as to separate the aggregated particles into discrete (dispersed) microspheres.

Using the above general procedure, various composite sol-gel microspheres, composed of various concentrations of the polystyrene and nanocrystal and entrapping a variety of semiconducting and other metallic nanocrystals of various shapes and sizes were prepared. In all the synthetic procedures, the amount of the ethanol, toluene, TEOS and ammonium hydroxide were the same, whereby the amount of the polystyrene and the amount, size, shape and composition of the nanocrystals were changed.

Table 1 below summarizes the components and conditions used in the various procedures for preparing the nanocrystals-entrapping composites and presents the size of resulting microspheres formed thereby.

TABLE 1

| | | | Polystyrene | Size of the |
|---|---|---|---|---|
| | Nanocrystal type | Nanocrystals | amount | resulting |
| entry | and size | amount (mg) | (mg) | microspheres |
| 1 | CdSe rods, 24.5 | 20 | 30 | 250 nm |
| | over 4.9 nm | | | |
| 2 | CdSe dots, 3.5 nm | 40 | 40 | 500 nm |
| 3 | CdSe dots, 6 nm | 20 | 50 | 780 nm |
| 4 | CdSe rods, 11 | 30 | 60 | 1000 nm |
| | over 3 nm | | | |
| 5 | CdSe rods, 15 | 35 | 30 | 300 nm |
| | over 3.8 nm | | | |
| 6 | PbSe dots, 10 nm | 50 | 40 | 500 nm |
| 7 | InAs/ZnSe CS, 4.3 nm | 20 | 35 | 400 nm |
| 8 | InAs/ZnSe CS, 6.3 nm | 20 | 35 | 400 nm |
| 9 | Au dots, 6 nm | 30 | 45 | 750 nm |

### Experimental and Analytical Results

Entrapment of Nanocrystals in the Sol-Gel/Polymer Composites:

Several types of optical measurements were first performed in order to verify the entrapment of the nanocrystals in the sol-gel/polystyrene microspheres.

Following the entrapment reaction, the first evidence for its success was provided by the appearance of a distinct color of the sediment containing the composites which was typical to the specific entrapped nanocrystal type and size, and in parallel the disappearance of that color from the solution.

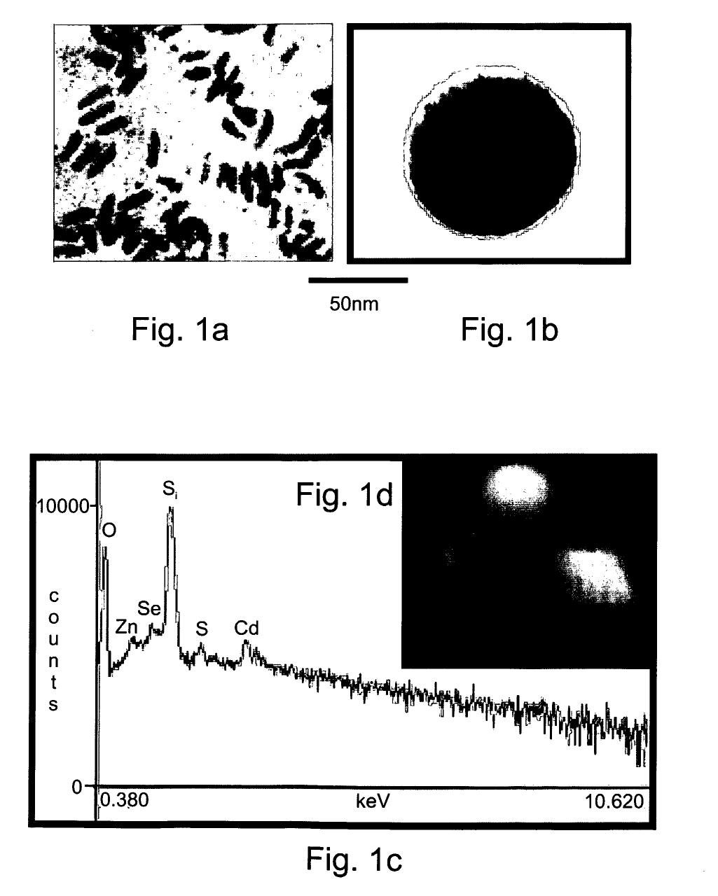

A more direct evidence for the entrapment of nanocrystals in the silica spheres was obtained from TEM images and energy dispersive X-ray spectroscopy (EDS) spectra as presented in FIG. 1.

FIG. 1a presents a TEM image of sol-gel/polystyrene microspheres entrapping CdSe/ZnS core/shell quantum rods with dimensions of 15 nm in length over 3.8 nm in diameter, corresponding to entry 5 of Table 1.

FIG. 1b presents a TEM image of an entire isolated sol-gel/polystyrene microsphere entrapping the CdSe/ZnS core/shell quantum rods, as describe for FIG. 1a. As can be seen in FIG. 1b, a single composite sphere having a diameter of about 100 nm is dotted with dark elongated forms of the nanocrystals positioned at random orientations inside the three-dimensional sphere.

FIG. 1c presents a spectra obtained by EDS measurements of silica/polystyrene composite microspheres entrapping CdSe/ZnS core/shell nanocrystals, corresponding to entry 2 of Table 1. As can be seen in FIG. 1c, a distinguished silicone peak from the silica component in the composite, distinguished cadmium and selenium peaks from the entrapped nanocrystal core, and distinguished zinc and sulfur peaks from the entrapped nanocrystal shell, were detected, providing a direct evidence for the entrapment of the nanocrystals within the composite spheres.

The insert in FIG. 1d presents a HRSEM (high resolution SEM) image of three composite microspheres entrapping CdSe/ZnS core/shell nanocrystals. As can be seen in FIG. 1d, these three clearly discrete composite microspheres exhibit a perfect spherical morphology of 500-600 nm in diameter.

Further direct evidence for encapsulation of nanocrystals, exhibited in the protective function of the silica/polystyrene microspheres was demonstrated when the photoluminescence of the samples was still observed after they have been exposed to air and ambient conditions for a period of one year.

Generality of Entrapment of Various Types of Nanocrystals:

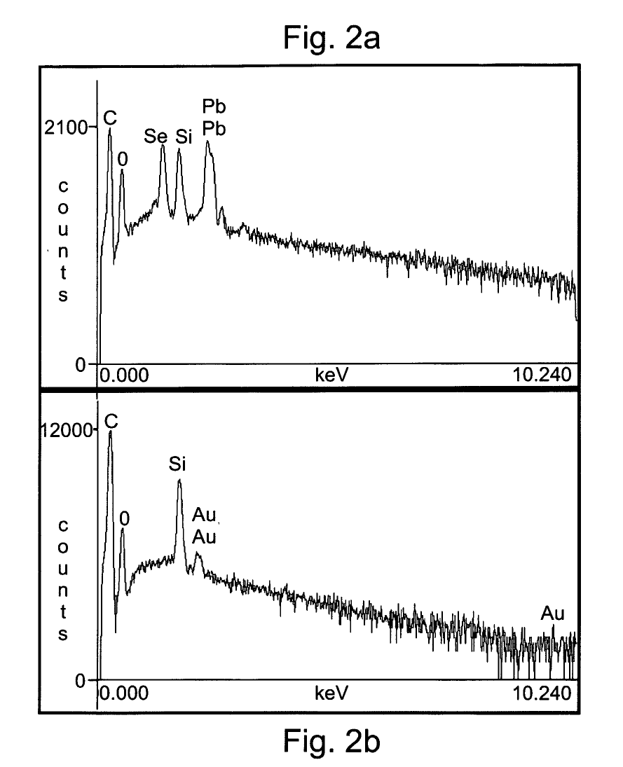

Entrapment of hydrophobic nanocrystals, using the above described methodology, was further practiced with gold (Au) and PbSe nanocrystals (see, Table 1, entries 6 and 9, respectively). FIGS. 2a and 2b present the data obtained in EDS measurements of composite silica/polystyrene microspheres entrapping these nanocrystals, which provide solid proof of the entrapment of these nanocrystals in the composite microspheres.

As can be seen in FIG. 2a, peaks of silicone, lead and selenium are clearly distinguished.

As can be seen in FIG. 2b, peaks of silicone and gold are clearly distinguished.

These results provide a clear proof of the aptitude and generality of the method presented herein to entrap various nanocrystals in the composite microspheres described herein.

Discreteness of the Nanocrystal-Entrapping Composite Spheres:

In order to obtain discrete (and mono-dispersed) composite microspheres, the effects of various parameters of the synthesis and preparation processes were tested. Various composite microspheres samples prepared at different conditions were analyzed by electron microscopy. It was found that the polystyrene (PS):TEOS ratio was a critical parameter regarding microspheres discreteness. The process of forming well-defined and discrete composite microspheres entrapping nanocrystals was therefore further optimized to the extent that well-separated and mono-disperse silica spheres could be obtained reproducibly.

Thus, a suitable PS:TEOS concentration ratio for obtaining a high yield of discrete composite microspheres was found to range from about 30 mg polystyrene/1 ml TEOS to about 70 mg polystyrene/1 ml TEOS.

As mentioned above, sonication for half an hour prior to deposition on the TEM grid was also found beneficial in breaking aggregates of microsphere which fused together after preparation in solution.

The TEM grid surface was also found to be an additional factor which contributed to the separation of the aggregates to discrete spheres when changing the TEM grid surface from carbon coated to carbon-formvar coated grids, which are more hydrophilic. The carbon-formvar coated grid surface attracted the silica spheres more strongly and reduced their mobility once deposited thereon.

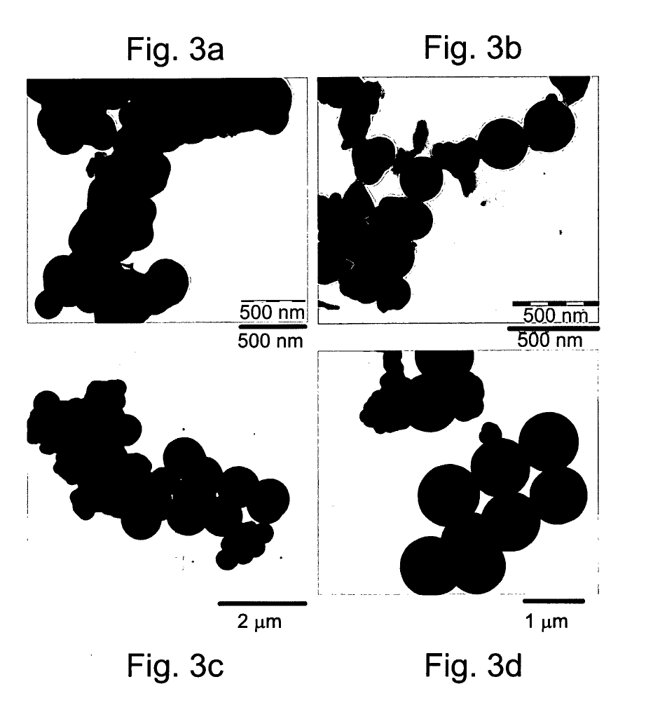

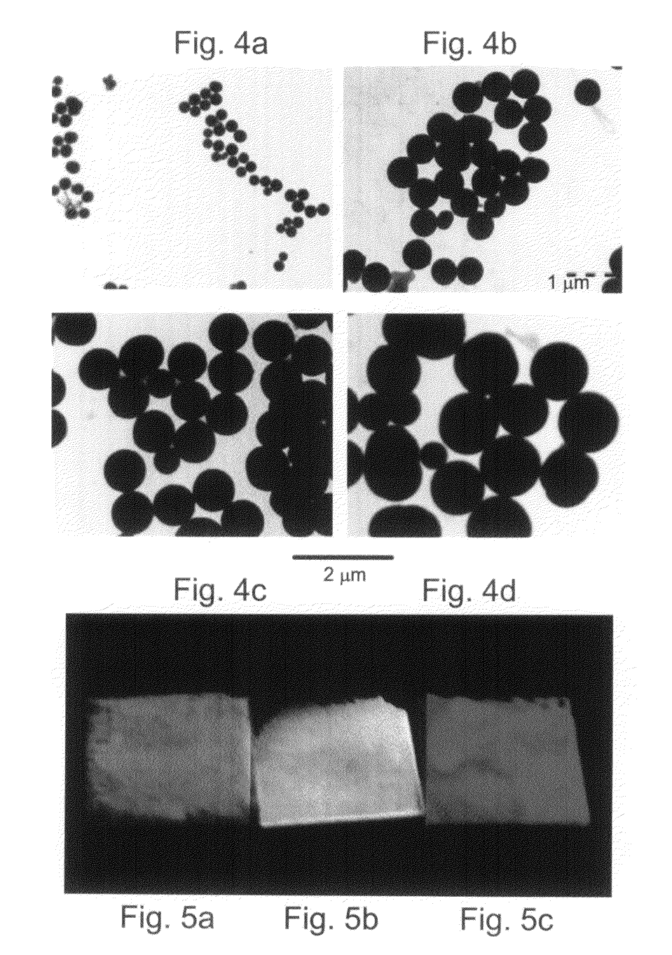

As can be seen in FIG. 1 and in FIGS. 3 and 4 discussed hereinbelow, well-separated discrete microspheres were achieved under these conditions.

FIG. 3 presents more TEM images of.

The effect of sonication prior to application on a TEM grid can be seen in FIGS. 3a and 3b, where TEM images of silica/polystyrene microspheres entrapping CdSe/ZnS core/shell nano-rods having dimensions of 15 nm over 3.8 nm, prepared as described above are presented. FIG. 3a presents images of aggregated composites formed when no sonication was applied, whereby FIG. 3b clearly demonstrates the effect of the sonication applied for 30 minutes on these microspheres.

The effect of the TEM grid surface can be seen in FIGS. 3c and 3d, where TEM images of microspheres applied on a carbon coated grid (FIG. 3c) show less distinguishable microspheres as compared to the microspheres which were applied on a carbon-formvar coated grid (FIG. 3d).

Size and Size Distribution of the Nanocrystal-Entrapping Composite Spheres:

Another significant goal in the process of preparing the composite microspheres entrapping nanocrystals presented herein is the ability to control the size thereof and to achieve a narrow distribution of their overall size (monodispersivity).

In order to obtain mono-dispersed populations of composite microspheres (having a controlled and narrow size distribution), the effects of various parameters on these characteristics were examined. Thus, various composite microspheres prepared at different conditions were analyzed by electron microscopy.

As in the studies for discreteness of the composite microspheres, the polystyrene (PS):TEOS ratio was found to be the main microsphere size-determining parameter.

FIG. 4a-d present TEM images of various nanocrystals-entrapping composite silica/PS microspheres. As can be seen in FIGS. 4a-d, the ability to control the size and size distribution was improved mainly by modifying the concentration of the polymer in the preparation procedure.

FIG. 4a presents a TEM image of silica/PS microspheres entrapping CdSe/ZnS core/shell nano-rods of 24.5 nm over 4.9 nm, corresponding to entry 1 of Table 1 hereinabove. As can be seen in FIG. 4a, these microspheres have a diameter of 0.25 μm and a substantially narrow size distribution.

FIG. 4b presents a TEM image of silica/PS microspheres entrapping CdSe/ZnS core/shell nano-dots of 3.5 nm in diameter, corresponding to entry 2 of Table 1 hereinabove. As can be seen in FIG. 4b, these microspheres have a diameter of 0.5 μm and a substantially narrow size distribution.

FIG. 4c presents a TEM image of silica/PS microspheres entrapping CdSe nano-dots of 6 nm in diameter, corresponding to entry 3 of Table 1 hereinabove. As can be seen in FIG. 4c, these microspheres have a diameter of 0.78 μm and a substantially narrow size distribution.

FIG. 4d presents a TEM image of silica/PS microspheres entrapping CdSe/ZnS core/shell nano-rods of 11 nm over 3 nm, corresponding to entry 4 of Table 1 hereinabove. As can be seen in FIG. 4d, these microspheres have a diameter of 1 μm and a substantially narrow size distribution.

Optical Properties of the Composite Spheres:

One of the more desired traits of nanocrystals is a finely tunable photo-electronic behavior, expressed in, e.g., the photoluminescence response thereof. To this end, several types of optical measurements were performed in order to study the effect of entrapment of the nanocrystals in composite silica/polystyrene microspheres.

Thus, visual inspections of fluorescence of UV lit composite silica/polystyrene microspheres entrapping nanocrystals of various types and sizes were carried out. The results are presented in FIGS. 5-7.

FIGS. 5a-c present color images of UV lit films of composite silica/polystyrene microspheres entrapping luminescent CdSe/ZnS core/shell semiconducting nanocrystals. As can be seen in FIG. 5a, green emission was observed from composite silica/polystyrene microspheres entrapping 11 nm over 3 nm CdSe/ZnS nano-rods, corresponding to entry 4 of Table 1. As can be seen in FIG. 5b, yellow emission was observed from composite silica/polystyrene microspheres entrapping 3.6 nm CdSe/ZnS nano-dots, corresponding to entry 2 of Table 1. As can be seen in FIG. 5c, red emission was observed from composite silica/polystyrene microspheres entrapping 25 nm over 4.5 nm CdSe/ZnS nano-rods, corresponding to entry 1 of Table 1.

A detailed study of the optical properties of isolated microspheres was conducted using a scanning fluorescence microscope. The emission spectrum of isolated microspheres was measured by placing the scanning fluorescence microscope lens above each microsphere and directing the light to a monochromator-CCD measurement system.

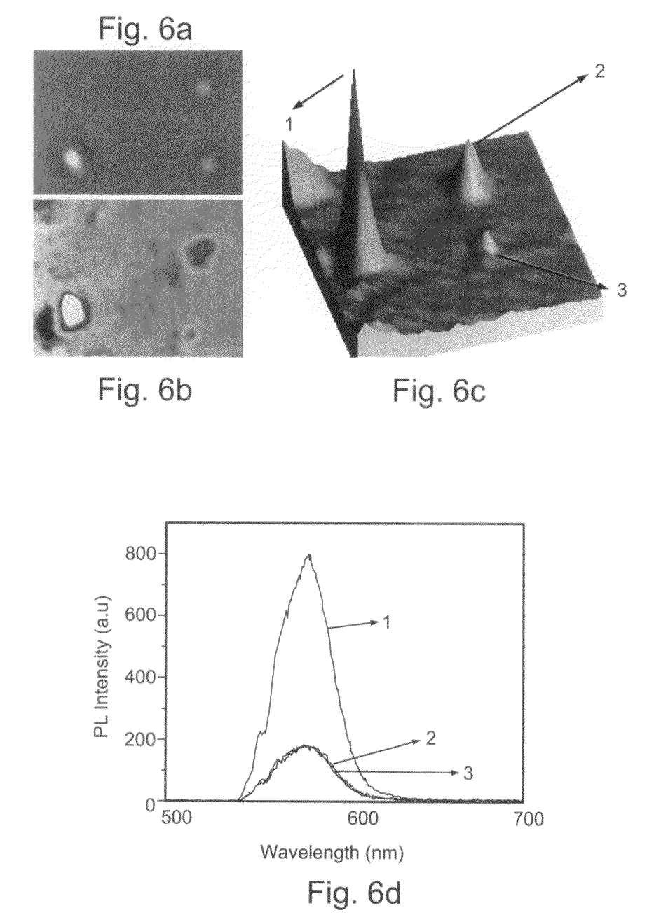

FIGS. 6a-d present the results of scanning fluorescence microscopy of three composite silica/polystyrene microspheres of about 500 nm in diameter, entrapping CdSe/ZnS core/shell nano-dots of 3.8 nm in diameter.

FIG. 6a presents a far field optical image of the microspheres obtained with a digital camera coupled to an inverted microscope with an X100 oil immersion objective under lamp illumination. Photoluminescence photon distribution maps for the three microspheres deposited onto a microscope glass coverslip, which were collected under illumination with an Ar+ ion laser at 514 nm excitation and intensity of 1 μw using a long pass filter to reject the excitation light, are presented in FIGS. 6b (two-dimensional projection) and 3c (three-dimensional presentation). The stronger peak on the left of the images corresponds to an aggregate of at least two composite microspheres. FIG. 6d presents the corresponding photoluminescence intensity spectra observed for these three microspheres, as collected and measured at different integration times on the scanning fluorescence microscope.

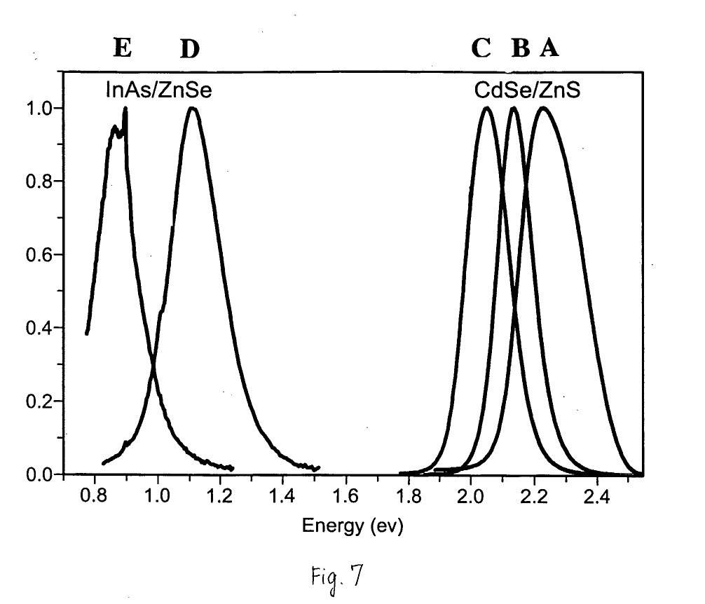

FIG. 7 presents photoluminescence spectra of three exemplary silica/PS microspheres entrapping CdSe/ZnS nanocrystals, spanning the visible range from 556 nm for entrapped core/shell nano-rods of 11 nm over 3 nm in size (denoted A), through 586 nm for core/shell nano-dots of 3.8 nm in diameter (denoted B), to a peak of 605 nm for core/shell nano-rods of 25 nm over 4 nm in size (denoted C). Also shown in FIG. 7 are spectra of exemplary silica/PS microspheres entrapping InAs/ZnSe core/shell nano-dots of different sizes, spanning the near IR range from 1100 nm for InAs/ZnSe nanocrystals of diameter 4.3 nm, corresponding to entry 7 of Table 1 (denoted D) to 1450 nm for InAs/ZnSe nanocrystals of 6.3 nm in diameter, corresponding to entry 8 of Table 1 (denoted E).

Additionally, InAs based nanocrystals which provide fluorescence in the near infrared range, were entrapped in composite sol-gel/polystyrene microspheres (data not shown).

The observations presented in FIG. 7 clearly demonstrate the applicability of the entrapment method presented herein to a variety of nanocrystals having different chemical compositions and shapes. As can be seen in FIG. 7 the entrapment leads to a decrease in the fluorescence quantum yield (QY). This may be due to the effect of surface traps created upon exposing the nanocrystals to water during the process.

In conclusion the general method for entrapping pre-prepared hydrophobic nanocrystals into micron and sub-micron silica/polystyrene spheres was exemplified hereinabove. In particular, the entrapment of semiconductor nanocrystals which imparts optical functionality to the composite microspheres, with very broad spectral coverage as dictated by the size, composition and shape of the entrapped semiconductor nanocrystals was demonstrated. It has been shown that this methodology can be applied to a variety of nanocrystals having spherical and/or rod shape. The size of the composite microspheres can be tuned from about 100 nm to several microns with high level of monodispersivity. The method can clearly be expanded to entrap nanocrystals of metals as demonstrated herein for gold. There is no apparent limit to use the methodology presented herein for entrapment of any type of hydrophobic nanocrystals of semiconductor, metal, magnetic or oxide nanocrystals. This method directly takes advantage of the significant developments in control of nanocrystals witnessed in recent years.

### Example 2

### Preparation of Sol-Gel/Polymer Composite Microspheres Entrapping Radioactive Nanocrystals

Encapsulation of radioactive nanocrystals (e.g., radioactive gold) is carried out according to the procedures described hereinabove.

Radioactive nanocrystals of ¹⁹⁸Au are prepared as described by Cao Y. W. and Banin, U. in J. Am. Chem. Soc., 2000, 122, 9692.

In a typical example, ethanol (12.5 ml), aqueous ammonium hydroxide (2.5 ml, 25% by volume) and Tween80 (0.5 ml) are mixed in a 100 ml flask to give a hydrophilic solution.

In parallel, a solution of coated (hydrophobic) nanocrystals of ¹⁹⁸Au (40 mg) in toluene (1.0 ml), TEOS (1.0 ml) and polystyrene (55 mg), is prepared in a separate vial to give a hydrophobic solution.

The hydrophobic solution is added to the hydrophilic solution at once and the resulting mixture is vigorously stirred overnight. During this time period, a pH of 11 is maintained.

The formed spheres are then subjected to centrifugation for 5 minutes followed by removal of the solvent under reduced pressure.

The process achieves radioactive silica/PS microspheres.

Similar process is used to obtain radioactive composite microspheres which entrap ¹¹¹InAs/ZnSe nanocrystals, and other nanocrystals that contain a radioactive isotope.

### Example 3

### Preparation of Functional Thin Layers

Composite silica/polystyrene microspheres entrapping 11 nm over 3 nm CdSe/ZnS nano-rods, corresponding to entry 4 in Table 1 hereinabove (see, Example 1), is used to prepare a functional thin layer coating a glass rod and a glass plate.

Preparation of a Functional Thin Layer on a Glass Rod by Means of a Dip-Coating Technique:

A glass rod having a round cross-section (5 cm in length) is placed in a dip-coating apparatus, and a 5 ml of the composite microspheres sample is placed in the cylindrical reservoir.

The apparatus is set in motion, lowering the glass rod holder at a rate of 1 cm per minute until 3 cm of the rod are dipped in the sample, and then set to raise the holder at a rate of 0.5 cm per minute until the rod is no longer dipped in the sample. The rod is allowed to dry for 2 hours at room temperature.

Preparation of a Functional Thin Layer on a Glass Plate by Means of a Spin-Coating Technique:

A round glass plate (4 cm in diameter and 0.5 cm thick) is placed in a spin-coating device, and 0.05 ml of the composite microspheres sample is placed onto the glass plate's top surface and in its center.

The device is set to spin at 2000-3000 rpm for 10 minutes, and the plate is thereafter allowed to dry for 1 hour at room temperature.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A composition comprising a plurality of spherical composites, wherein each of said spherical composite comprises at least one sol-gel metal oxide or semi-metal oxide and at least one hydrophobic polymer being entangled to one another, and further wherein at least one of said spherical composites comprises at least one nanoparticle entrapped therein.

2. The composition of claim 1, wherein at least one of said spherical composites further comprises at least one functionalizing group attached thereto.

3. The composition of claim 2, wherein said functionalizing group is selected from the group consisting of a chemical moiety and a bioactive moiety.

4. (canceled)

5. The composition of claim 1, wherein an average size of said spherical composites ranges from about 0.01 μm to about 100 μm in diameter.

6. (canceled)

7. The composition of claim 1, wherein at least 60% of said spherical composites have an average size that ranges from about 0.01 μm to about 10 μm in diameter.

8. (canceled)

9. The composition of claim 1, wherein said spherical composites are discrete from one another.

10. The composition of claim 1, wherein said at least one sol-gel metal oxide or semi-metal oxide is selected from the group consisting of SiO₂, TiO₂, ZrO₂, Al₂O₃, ZnO, SnO₂, MnO, an organically-modified derivative thereof, a functionalized derivative thereof and any mixture thereof.

11. The composition of claim 1, wherein said at least one sol-gel metal oxide or semi-metal oxide is prepared from a sol-gel precursor selected from the group consisting of a metal alkoxide monomer, a semi-metal alkoxide monomer, a metal ester monomer, a semi-metal ester monomer, a silazane monomer, a monomer of the formula M(R)n(P)m, wherein M is a metallic or a semi metallic element, R is a hydrolyzable substituent, n is an integer from 2 to 6, P is a non polymerizable substituent and m is and integer from 0 to 6, a partially hydrolyzed and partially condensed polymer thereof, and any mixture thereof.

12. (canceled)

13. The composition of claim 1, wherein said at least one hydrophobic polymer is selected from the group consisting of a polyolefin, a polyaromatic, a polyalkylacrylate, a polyoxirane, a polydiene, a polylactone(lactide), a co-polymer thereof, a functionalized derivative thereof and any mixture thereof.

14-15. (canceled)

16. The composition of claim 1, wherein said at least one nanoparticle is a hydrophobic nanoparticle.

17-21. (canceled)

22. The composition of claim 1, wherein said spherical composites exhibit a functional characteristic of said at least one nanoparticle.

23. (canceled)

24. A process of preparing a plurality of spherical composites, wherein each spherical composite comprises at least one sol-gel metal oxide or semi-metal oxide and at least one hydrophobic polymer, and further wherein at least one of said spherical composites comprises at least one nanoparticle entrapped therein, the process comprising:
providing a hydrophobic solution which comprises at least one sol-gel precursor, said at least one hydrophobic polymer and said at least one nanoparticle; and
mixing said hydrophobic solution with a hydrophilic solution, to thereby obtain a mixture containing the plurality of the spherical composites.

25. The process of claim 24, wherein said spherical composites further comprise at least one functionalizing group attached thereto, whereas at least one of said sol-gel precursor and said hydrophobic polymer comprises said functionalizing group.

26. The process of claim 24, wherein said spherical composites further comprise at least one functionalizing group attached thereto, the process further comprising:
reacting said spherical composites with a functionalizing moiety, to thereby obtain said spherical composites having said functionalizing group attached thereto.

27. The process of claim 24, wherein said hydrophobic solution further comprises a hydrophobic solvent.

28. The process of claim 24, wherein said hydrophilic solution further comprises a hydrophilic solvent.

29. The process of claim 24, wherein said hydrophilic solution further comprises a catalyst.

30. The process of claim 24, wherein said hydrophilic solution further comprises a surfactant.

31. The process of claim 24, further comprising separating the composite microspheres from said mixture.

32-36. (canceled)

37. The process of claim 24, wherein said at least one nanoparticle is selected from the group consisting of a chromogenic nanoparticle, a semiconducting nanoparticle, a metallic nanoparticle, a magnetic nanoparticle, an oxide nanoparticle, a fluorescent nanoparticle, a luminescent nanoparticle, a phosphorescent nanoparticle, an optically active nanoparticle and a radioactive nanoparticle.

38. The process of claim 24, wherein said at least one nanoparticle is a hydrophobic nanoparticle.

39. The process of claim 24, wherein said at least one hydrophobic polymer is selected from the group consisting of a polyolefin, a polyaromatic, a polyalkylacrylate, a polyoxirane, a polydiene, a polylactone(lactide), a co-polymer thereof, a functionalized derivative thereof and any mixture thereof.

40. (canceled)

41. The process of claim 24, wherein said at least one sol-gel precursor selected from the group consisting of a metal alkoxide monomer, a semi-metal alkoxide monomer, a metal ester monomer, a semi-metal ester monomer, a silazane monomer, a monomer of the formula M(R)n(P)m, wherein M is a metallic or a semi metallic element, R is a hydrolyzable substituent, n is an integer from 2 to 6, P is a non polymerizable substituent and m is and integer from 0 to 6, a partially hydrolyzed and partially condensed polymer thereof, and any mixture thereof.

42. The process of claim 24, wherein said at least one sol-gel precursor is a silicone alkoxide.

43. A spherical composite comprising an entrapping matrix which comprises at least one sol-gel metal oxide or semi-metal oxide being entangled to one another and at least one hydrophobic polymer, and at least one nanoparticle being entrapped in said matrix.

44. The spherical composite of claim 43, further comprising at least one functionalizing group attached thereto.

45. The spherical composite of claim 44, wherein said at least one functionalizing group is selected from the group consisting of a chemical moiety and a bioactive moiety.

46. (canceled)

47. The spherical composite of claim 43, having a size that ranges from about 0.01 μm to about 100 μm in diameter.

48. (canceled)

49. The spherical composite of claim 43, wherein said at least one sol-gel metal oxide or semi-metal oxide is selected from the group consisting of SiO₂, TiO₂, ZrO₂, Al₂O₃, ZnO, SnO₂, MnO, an organically-modified derivative thereof, a functionalized derivative thereof and any mixture thereof.

50. The spherical composite of claim 43, wherein said at least one sol-gel metal oxide or semi-metal oxide is prepared from a sol-gel precursor selected from the group consisting of a metal alkoxide monomer, a semi-metal alkoxide monomer, a metal ester monomer, a semi-metal ester monomer, a silazane monomer, a monomer of the formula M(R)n(P)m, wherein M is a metallic or a semi metallic element, R is a hydrolyzable substituent, n is an integer from 2 to 6, P is a non polymerizable substituent and m is and integer from 0 to 6, a partially hydrolyzed and partially condensed polymer thereof, and any mixture thereof.

51. The spherical composite of claim 43, wherein said at least one hydrophobic polymer is selected from the group consisting of a polyolefin, a polyaromatic, a polyalkylacrylate, a polyoxirane, a polydiene, a polylactone(lactide), a co-polymer thereof, a functionalized derivative thereof and any mixture thereof.

52. (canceled)

53. The spherical composite of claim 43, wherein said at least one nanoparticle is selected from the group consisting of a chromogenic nanoparticle, a semiconducting nanoparticle, a metallic nanoparticle, a magnetic nanoparticle, an oxide nanoparticle, a fluorescent nanoparticle, a luminescent nanoparticle, a phosphorescent nanoparticle, an optically active nanoparticle and a radioactive nanoparticle.

54. The spherical composite of claim 43, exhibiting a functional characteristic of said at least one nanoparticle.

55. (canceled)

56. A functional thin layer comprising the composition of claim 1.

57. An article-of-manufacture comprising the composition of claim 1.

58. (canceled)
